(19) United States
(12) Patent Application Publication
(10) Pub. No.: US 2026/0091788 A1
(43) Pub. Date: Apr. 2, 2026

(54) Merging Detection and Mitigation

(71) Applicant: Nissan North America, Inc., Franklin, TN (US)

(72) Inventors: Derek Lau, San Francisco, CA (US); Christopher Ostafew, Mountain View, CA (US)

(21) Appl. No.: 18/902,272

(22) Filed: Sep. 30, 2024

(51) Int. Cl. B60W 50/00; B60W 60/00

(52) U.S. Cl. CPC B60W 50/0097; B60W 60/001; B60W 2520/10; B60W 2552/05; B60W 2554/4042; B60W 2554/4049; B60W 2554/804

(57) ABSTRACT

Determining a speed plan for an autonomous vehicle (AV) is disclosed. A path of the AV in a lane of a road is predicted. A path of an other road user (ORU) vehicle in the lane of the road is also predicted. An interaction time between the AV and the ORU vehicle is determined. A classification of the ORU vehicle is determined based on the interaction time and the predicted path of the AV. A speed of the AV is established based on the classification of the ORU vehicle.

### TECHNICAL FIELD

This application relates to autonomous driving and, more particularly, to using detecting and mitigating issues associated with merging vehicles in the context of an autonomous vehicle.

### BACKGROUND

Increasing autonomous vehicle usage creates the potential for more efficient movement of passengers and cargo through a transportation network. Moreover, the use of autonomous vehicles can result in improved vehicle safety and more effective communication between vehicles. However, external objects make traversing the transportation network autonomously difficult.

### SUMMARY

A first aspect of the disclosed implementations is a method for generating a speed profile for an autonomous vehicle (AV). The method includes predicting a path of the AV in a lane of a road. The method further includes predicting a path of an other road user (ORU) vehicle in the lane of the road. The method further includes determining an interaction time between the AV and the ORU vehicle and determining a classification of the ORU vehicle based on the interaction time and the predicted path of the AV. The method further includes establishing a speed of the AV based on the classification of the ORU vehicle.

A second aspect of the disclosed implementations is an AV that includes a memory and a processor. The processor is configured to execute instructions stored in the memory to detect an additional ORU vehicle in the lane of the road, determine an additional predicted distance of the additional ORU vehicle at the interaction time, determine a first time headway parameter for the ORU vehicle and a second time headway parameter for the additional ORU vehicle, determine an upper bound constraint for the AV based on the first time headway parameter and the second time headway parameter; determine a lower bound constraint for the AV based on the first time headway parameter, and establish the speed of the AV based on the upper bound constraint and the lower bound constraint.

A third aspect of the disclosed implementations is a non-transitory computer-readable medium storing instructions operable to cause one or more processors to perform operations. The operations include predicting a path of an AV in a lane of a road, predicting a path of an ORU vehicle in the lane of the road, determining an interaction time between the AV and the ORU vehicle. determining a classification of the ORU vehicle based on the interaction time and the predicted path of the AV, and establishing a speed of the AV based on the classification of the ORU vehicle.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 illustrates a system that includes an optimized speed plan tool (OSP) for constraint-based speed profile generation.

FIG. 4 is a process flow that illustrates the operations of the OSP tool of FIG. 3.

FIG. 5 illustrates an example of setting upper limits in the occupancy grid.

FIG. 6 illustrates an example of adding world objects to an occupancy grid.

FIG. 7 illustrates another example of adding world objects to an occupancy grid.

FIG. 8 illustrates an example of a speed plan and an example of a smoothed speed plan.

FIG. 9 is a process flow that illustrates an example of a process for using merge detection and mitigation for generating a constraint-based speed plan.

FIGS. 10A-10D illustrate examples associated with classifying an other road user (ORU) vehicle as a Go Before vehicle or a Go After vehicle.

FIGS. 11A and 11B illustrate examples associated with classifying multiple ORU vehicles as Go Before vehicles and/or Go After vehicles.

FIGS. 12A and 12B illustrate examples associated with analysis of uncertainty in classifying ORU vehicles as Go Before vehicles and/or Go After vehicles.

FIG. 13 illustrates an example associated with constraint modification for merging onto a road.

FIGS. 14A-14D illustrate examples associated with merging from a slower road onto a faster road.

FIGS. 15A-15C illustrate examples associated with merge detection and mitigation in scenarios associated with crossing vehicles.

FIGS. 16A-16D illustrate examples associated with merge detection and mitigation in scenarios associated with crossing multiple lanes of traffic.

FIG. 17 is a flowchart of an example of a technique for generating a speed profile of for an autonomous vehicle.

### DETAILED DESCRIPTION

A self-driving vehicle, such as an autonomous vehicle (AV) or a semi-autonomous vehicle that includes an advanced driver-assistance system (ADAS), may traverse a portion of a vehicle transportation network using information derived from sensors. For simplicity of explanation, and unless otherwise indicated, both AVs and ADAS-enabled vehicles are referred to as AVs.

An AV uses advanced sensors such as cameras, light detection and ranging (Lidar), radar, etc., to continuously scan monitor its scene (e.g., surrounding environment). Data from these sensors may be processed by onboard computers to create a detailed map of the scene. Combined with real-time traffic, Global Positioning System (GPS) information, and map information, an optimal route is determined for the AV. Advanced control systems enable quick decisions on acceleration, braking, and steering, ensuring safe navigation in dynamic settings.

A constraint-based speed profile integrates the planned locations (e.g., positions) of an AV (e.g., a host vehicle) and the predicted (e.g., anticipated) locations of external world objects that might obstruct the planned route of the AV into an occupancy grid. The planned locations of the AV are obtained from (e.g., based on) a strategic speed plan, while the predicted positions of external objects may be derived from hypotheses that the AV maintains (e.g., via internal components, software, or modules therein) with respect to the world objects. In certain scenarios, virtual world objects (e.g., occluded objects) may also be added to the occupancy grid.

A search algorithm then estimates a tactical speed plan (also referred to herein as a modified speed plan, detailed-planned trajectory, a short-term speed plan, or tactical speed plan), adjusting the initial strategic speed plan based on the world objects in the scene. The occupancy grid can be used to set constraints for a constraint-based optimization problem to solve for an optimal speed plan relative to the objects in the occupancy grid. A constraint-based speed profile can be calculated (e.g., obtained) at regular intervals (e.g., at every time step), ensuring that speed plan is continuously refined in response to the evolving scene, guaranteeing safe operation of the AV. To be clear, an estimated speed plan is obtained using the search algorithm; and then the speed plan is obtained from the estimated speed plan by solving an optimization problem. To be even clearer, while the output of the search algorithm is referred to as an “estimated speed plan,” the output is not technically a speed plan; rather, it is an estimate of the distance along the path the AV will travel over the time, relative to the occupied space in the occupancy grid. The estimated speed plan may not include any velocity or acceleration data-instead it can only include distance values at discrete time steps.

A “speed plan,” as used herein, can be a dataset that associates a vehicle speed with specific longitudinal positions or travel times during autonomous driving. The speed plan dictates the desired speed or other motion parameters (e.g., acceleration or jerk) for the AV at various points or moments on its (planned) route, ensuring the AV adheres to these targets as it navigates autonomously. Thus, the speed plan can include speeds and positions. Determining a speed plan can include identifying associated speeds (or motion parameters) for portions of a path identified by a route planner. The portions of the path are those corresponding to a planning window, as described herein. A “strategic” speed plan is a speed plan that is planned without taking into account other identified world objects. A “tactical” (or “modified”) speed plan modifies the strategic plan based on the world objects in the scene.

To describe some implementations of the teachings herein in greater detail, reference is first made to the environment in which this disclosure may be implemented.

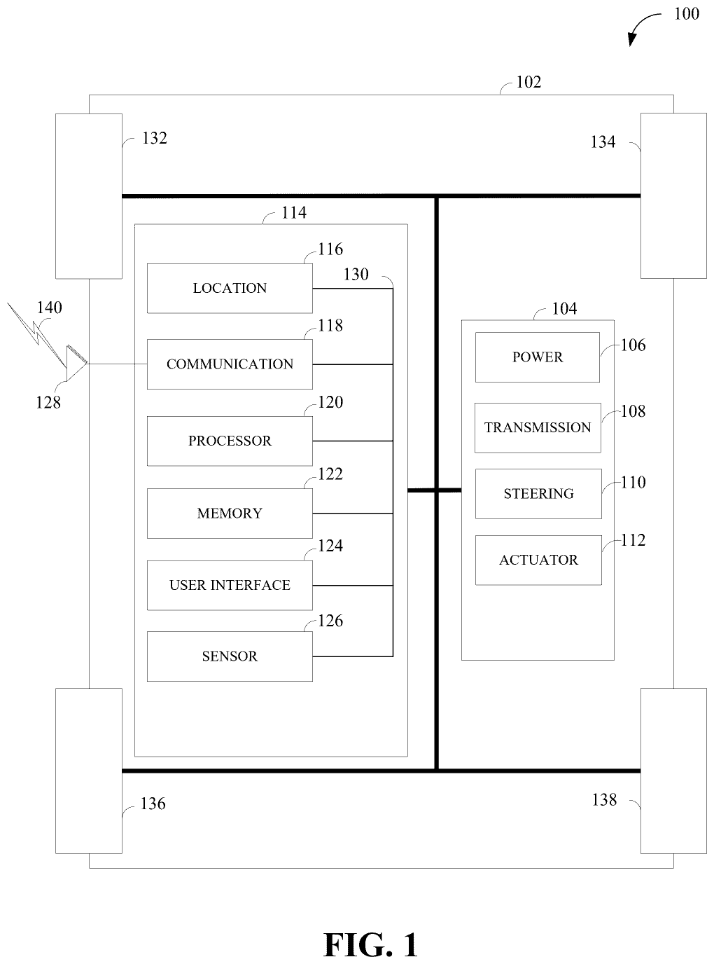

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals, power, such as electrical power or torque, or both information and power, may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and is operative to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), IEEE 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

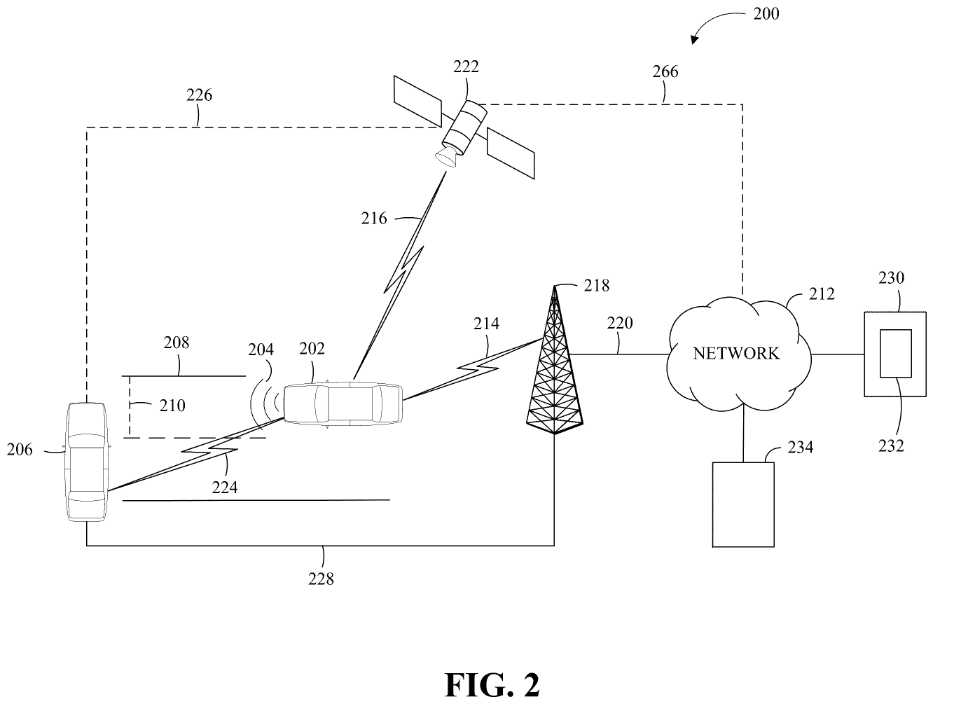

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

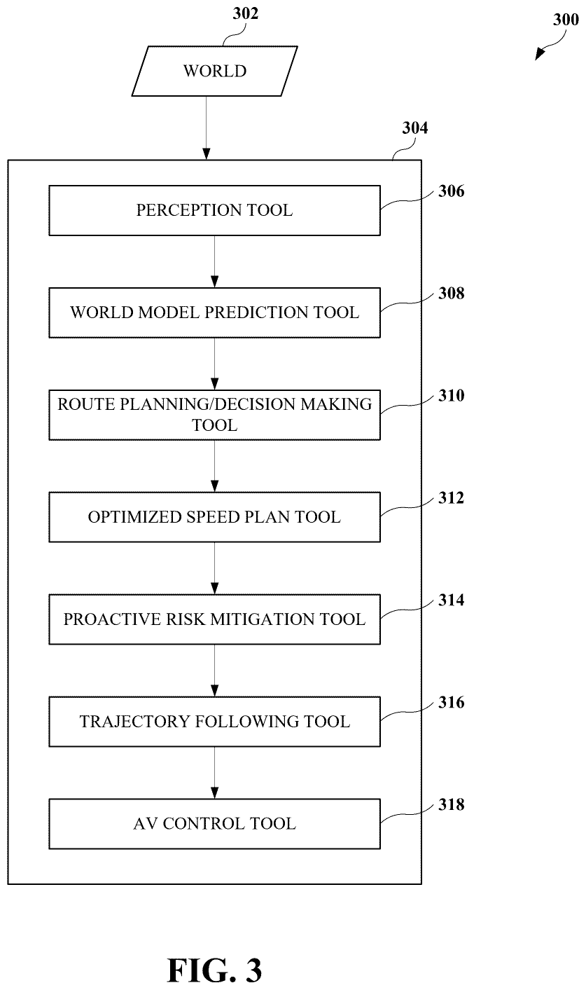

FIG. 3 illustrates a system that includes an optimized speed plan tool (OSP) for constraint-based speed profile generation. The system 300 includes a world 302 and an AV 304. The world 302 can be as described with respect to the transportation and communication system 200 of FIG. 2. As such, the world 302 can include other world objects that are traversing roads that may be included or described in a, e.g., high-definition (HD) map included in or accessible by the AV 304. The AV 304 can be the vehicle 100 of FIG. 1 or the vehicle 202 of FIG. 2.

The AV 304 includes a set of tools that may collectively to be referred to as the AV software stack. The AV software stack encompasses a set of algorithms that seamlessly collaborate to enable various aspects of the autonomous operations of the AV 304. The software stack may orchestrate sensor data fusion, perception, decision-making, and control to safely navigate and interact with the world 302.

The AV 304 (i.e., the AV software stack therein or associated therewith) is shown as including a perception tool 306, a world model prediction tool 308, a route planning/decision making tool 310, an OSP tool 312, a proactive risk mitigation tool 314, a trajectory following tool 316, and an AV control tool 318. The disclosure herein is mainly focused on the functional aspects, operations, and capabilities of the OSP tool 312.

At least some of the tools can be implemented as respective software programs that may be executed by one or more processors, such as the processor 120 of FIG. 1. A software program can include machine-readable instructions that may be stored in a memory such as the memory 122 of FIG. 1, and that, when executed by a processor, such as the processor 120, may cause the performance of the instructions of the software program. In some implementations, more or fewer tools may be included in the AV software stack. Some of the tools or aspects thereof may be implemented directly in hardware, firmware, software executed by hardware, circuitry, or a combination thereof.

The perception tool 306 includes sensors and obtains sensor data from the world 302. For example, the perception tool may obtain images of the world 302, points clouds corresponding to objects in the world 302, and so on. The world model prediction tool 308 receives the sensor data and determines (e.g., converts to, detects, etc.) world objects from the sensor data. That is, for example, the world model prediction tool 308 determines the world objects from the received sensor data. For example, the world model prediction tool 308 can convert a point cloud received from a Lidar sensor (i.e., a sensor of the sensor 126) into a world object. Sensor data from several sensors can be fused together to determine (e.g., guess the identity of, classify, etc.) the world objects. Examples of world objects include a bicycle, a pedestrian, and a vehicle.

The world model prediction tool 308 can receive sensor information that allows the world model prediction tool 308 to obtain (e.g., determine, calculate, identify, select, etc.) and maintain additional information for at least some of the detected world objects. For example, the world model prediction tool 308 can maintain respective states for at least some of the determined world objects. For example, the state associated with a world object can include zero or more of a velocity, a pose, a geometry (such as width, height, and depth), a classification (e.g., bicycle, large truck, pedestrian, road sign, etc.), and a location. As such, the state of an object includes discrete state information (e.g., classification) and continuous state information (e.g., pose and velocity).

The world model prediction tool 308 fuses sensor information, tracks world objects, maintains lists of hypotheses for at least some of the dynamic objects (e.g., an object A might be going straight, turning right, or turning left), creates and maintains predicted trajectories for each hypothesis, and maintains likelihood estimates of each hypothesis (e.g., object A is going straight with probability of 90% considering the object pose/velocity and the trajectory poses/velocities).

The route planning/decision making tool 310 determines a road-level plan. For example, given a starting location and a destination location, the route planning/decision making tool 310 determines a route from the starting location to the destination location. The route planning/decision making tool 310 can determine the list of roads (i.e., the road-level plan) to be followed by the AV to navigate from the starting location to the destination location.

The route planning/decision making tool 310 determines (e.g., identifies) decisions along the road-level plan. High level descriptive examples of discrete-level decisions may include: stop at the interaction between road A and road B, move forward slowly, accelerate to a certain speed limit and then merge onto the rightmost lane, prepare to stop because a stop light may be turning red, etc. The decisions may be based on data included in the map. For example, the map may indicate the presence of a traffic light or that a lane merges onto another and so on. The output of the route planning/decision making tool 310 may be referred to as a strategic speed plan. As mentioned above, the speed plan is “strategic” because it is planned without taking into account the other identified world objects. While FIG. 3 illustrates that route planning/decision making tool 310 may follow the world model prediction tool 308, that need not be the case.

The OSP tool 312, which is further described herein, modifies the strategic speed plan based on world objects that may interfere with the path (e.g., with the strategic speed plan) of the AV 304 based on an occupancy grid. The OSP tool 312 can be said to plan for a current scenario (e.g., world objects observed in the scene at a current time step t₀) as well as how the scenario will develop at future time steps (tₙ, where n=1, . . . , N) within a planning horizon (e.g., 6 seconds into the future or any other number of seconds). The planning horizon can be divided into a pre-defined number of time steps N. The OSP tool 312 accounts for multiple world objects interacting with the AV 304. That is, the OSP tool 312 can handle multiple constraints related to multiple respective world objects at once (e.g., simultaneously).

Whereas the route planning/decision making tool 310 generates a strategic speed plan, the OSP tool 312 may modify the strategic speed plan (more accurately, the portion of the strategic speed plan corresponding to the planning window, also referred to as a time horizon) to obtain a tactical speed plan (or a detailed-planned trajectory). The OSP tool 312 can receive the discrete-level decisions of the strategic speed plan, the world objects (and corresponding state information), and the predicted trajectories and likelihoods of the external objects. The OSP tool 312 can use at least some of the received information to determine the detailed-planned trajectory (e.g., the tactical speed plan) for the AV 304.

The OSP tool 312 can be summarized as performing the steps of filling out (e.g., generating, constructing, updating, etc.) an occupancy grid, performing a search algorithm to identify an estimated path, smoothing the estimated path, adding stop conditions, formulating constraints, and then solving an optimization problem based on the constraints. The solution to the optimization problem is the short-term or tactical speed plan.

Further discussion of scenarios where the AV is merging into a lane or is dealing with one or more vehicles merging into the AV lane are described below with respect to the OSP tool 312.

The proactive risk mitigation tool 314 may further adjust the tactical speed plan to account for potential hazards. A potential hazard is one that is not currently determined to interfere with the path of the AV 304 but which might in the future. To illustrate, a vehicle may be parked at a side of a street. The driver's door is currently closed. As such, the door does not currently interfere with the path of the AV 304. However, the door may open in the future and may cause the AV to perform an emergency maneuver to avoid the door. Another example of a potential hazard may be a vehicle that is predicted to merge into a lane in which the AV is traveling.

The proactive risk mitigation tool 314 considers the reactive capabilities of the AV 304 in planning a proactive trajectory for the vehicle that minimizes speed and/or lateral changes in movement responsive to a potential hazard while still allowing for a comfortable and safe reactive response (i.e., a reactive trajectory) in the event a hazard object interferes with the path of the vehicle. A proactive trajectory for the AV 304 may be determined that adjusts the planned path and speed proactively for collision avoidance if the hazard object materializes as predicted. The proactive trajectory is such that if the hazard materializes, the AV 304 would not have to make an emergency, evading maneuver that would be uncomfortable for occupants of the AV 304. Again, with respect to the door scenario, the AV 304 may be moved just enough to the left.

The trajectory following tool 316 produces control signals (e.g., steering, acceleration, etc.) to cause the AV 304 to be controlled according to the output of the route planning/decision making tool 310. The route planning/decision making tool 310 may operate at a first frequency (e.g., 10 Hertz) and the trajectory following tool 316 may operate at a second, different, frequency (e.g., 100 Hertz). The AV control tool 318 may output control signals to control actuators of the AV 304 so that the AV 304 is controlled according to the speed plan.

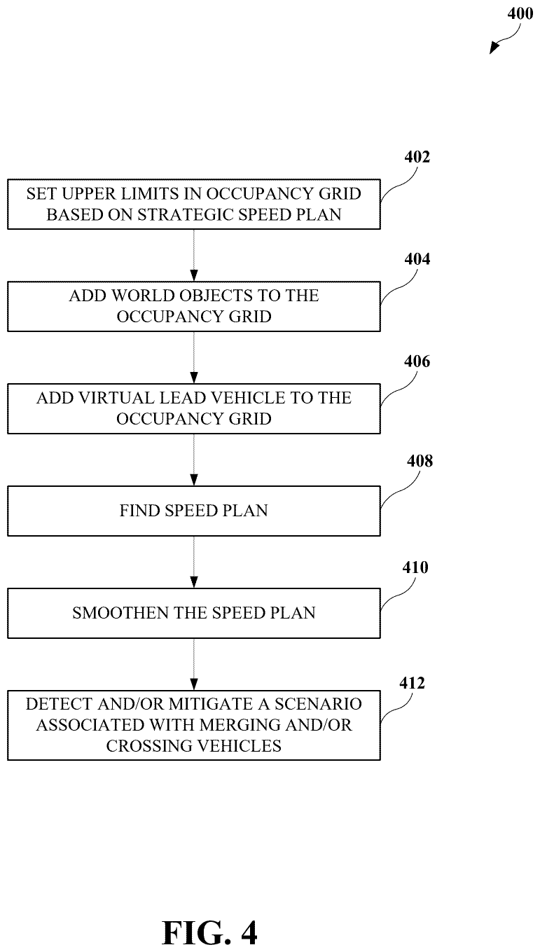

FIG. 4 is a process flow 400 that illustrates the operations of the OSP tool 312 of FIG. 3. The OSP tool 312 constructs an occupancy grid that includes an AV and other world objects. Constraints are associated with the other world objects. A search algorithm is used to find a path (e.g., a tactical speed plan) for the AV based on the occupancy grid. In an example, an A* (pronounced A-star) search algorithm is used. However, other search algorithms are possible.

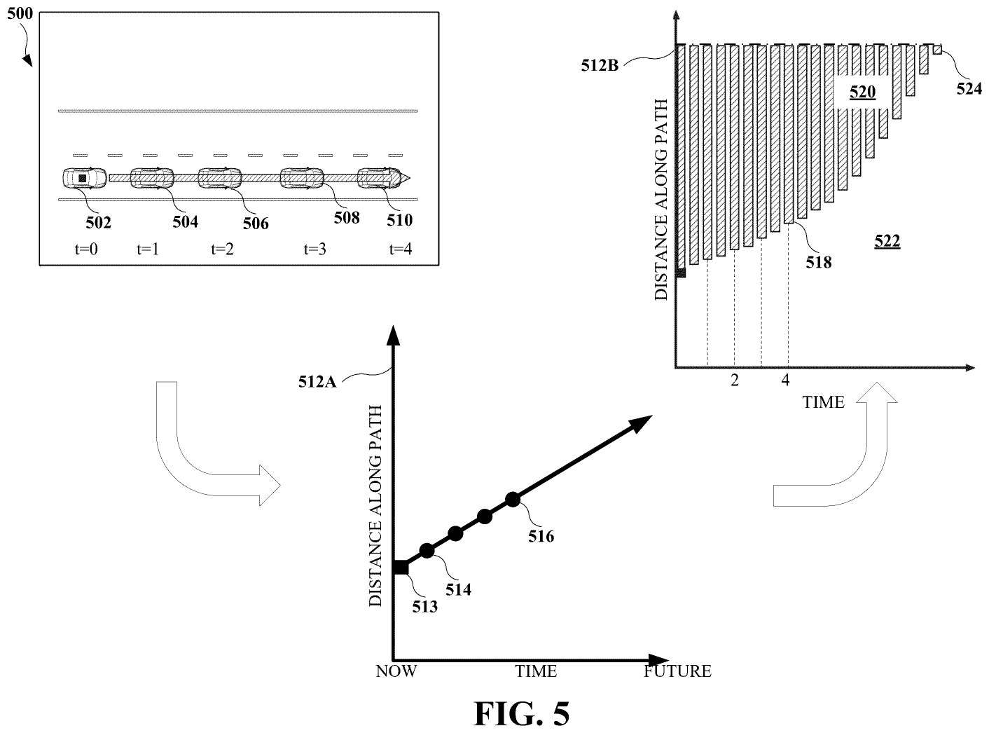

For ease of understanding, visual representations of occupancy grids are described herein. However, any suitable data structure maintainable in a memory, such as the memory 122 of FIG. 1, and usable by the search algorithm can be used. An occupancy grid can be thought of as a tool to visualize and store constraints relative to distance and time as the AV travels along its path. The occupancy grid essentially stores constraints (further described herein) that are relevant to the path of the AV. The process flow 400 is further described with reference to FIGS. 5-12.

At 402, upper limits are set in (e.g., added to) the occupancy grid based on the strategic speed plan. Upper limits set the possible distances that the AV could be based on its predicted future locations based on the strategic speed plan.

FIG. 5 illustrates an example 500 of setting upper limits in the occupancy grid. The locations of an AV 502 within the planning window (e.g., time horizon) and according the strategic speed plan are identified. The example 500 illustrates that the AV 502 is planned to be at locations 504, 506, 508, 510, etc. at time steps t=1, t=2, t=3, t=4, etc., respectively. The planned locations are placed in an occupancy grid 512A. The occupancy grid 512A is a two-dimensional graph where the x-axis represents time and the y-axis represents distance along the path of the AV 502 from a current location 513 (e.g., the location at time step t=0) of the AV 502. More specifically, the y-axis can indicate distance traveled by the AV 502 from one step to the immediately succeeding time step. The occupancy grid illustrates that points 514 and 516 of an occupancy grid 512A correspond to the locations 504 and 510, respectively.

While the locations may visually appear to be equally spaced in FIG. 5, that may not necessarily be the case as the strategic speed plan is generated relative to (e.g., based on) road speed limits and road curvatures. Additionally, the road speed limits and road curvatures act as (e.g., are used to set) the upper limit of how fast the AV 502 can drive with no other road users present. An occupancy grid 512B shows that the occupancy grid 512A has been updated to include the upper limits.

Each of the vertical bars, such as a vertical bar 518, indicates possible locations of the AV 502 at the corresponding time step. For example, the vertical bar 518 illustrates the possible locations of the AV 502 at t=4. An area 520 illustrates possible positions of the AV 502 if the AV 502 were to be moving faster than the speed indicated by the strategic speed plan. An area 522 would include positions of the AV 502 if the AV 502 were to be moving slower than the speed indicated by the strategic speed plan. The occupancy grid 512B includes vertical bars (upper limits) corresponding the time steps of the planning window. As such, a vertical bar 524 corresponds to the last time step in the current planning window.

Referring again to FIG. 4, at 404, some of the world objects are added to the occupancy grid. More specifically, world objects whose paths are predicted to interact with that of the AV are added to the occupancy grid. Adding a world object to the occupancy grid includes adding the predicted locations of the world object to the occupancy grid. Distances that are based on the predicted paths of the respective world objects are added to the occupancy grid. Buffer distances are also added to the occupancy grid. The distances and the buffer distances are based on whether the world object is classified as an along path world object or a crossing world object. An along path world object is one that is traveling in the same direction as the AV and the AV and world object are currently or will be in the same road lane. A crossing world object is one whose path crosses (e.g., intersects) that of the AV.

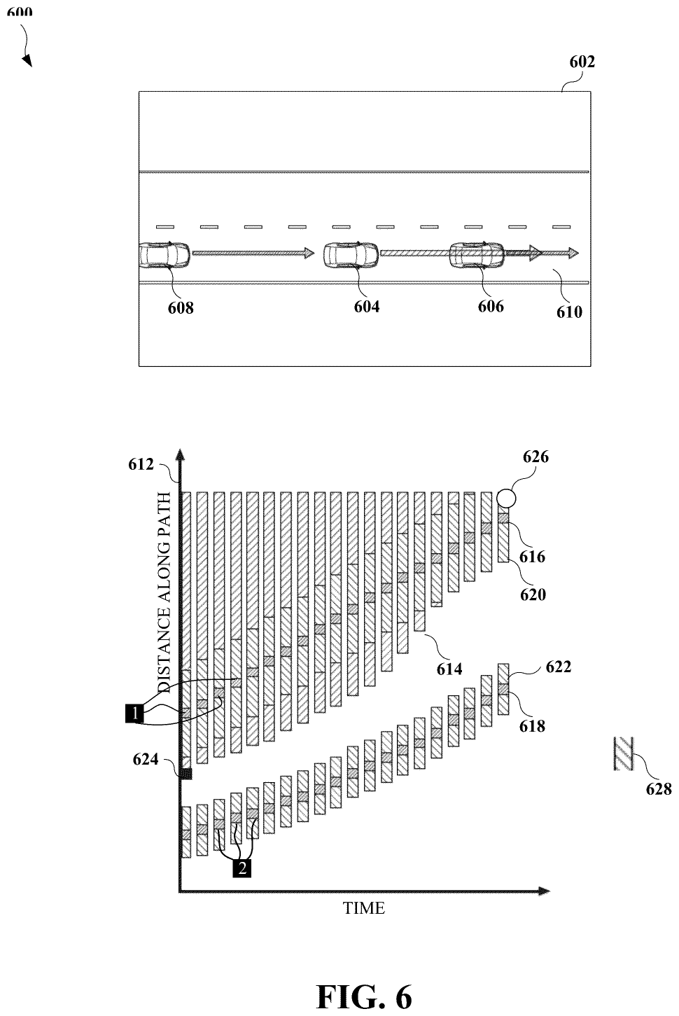

FIG. 6 illustrates an example 600 of adding along world objects to an occupancy grid. A scene 602 illustrates that an AV 604, a leading vehicle 606 (e.g., a vehicle that is ahead of the AV 604), and a trailing vehicle 608 (e.g., a vehicle that is behind the AV 604) are traveling in the same direction along a lane 610. As such, both of the leading vehicle 606 and the trailing vehicle 608 are classified as along world objects. An occupancy grid 612 has been generated and includes upper limits, as described above. As such, a vertical bar 614 can be similar to the vertical bar 518 of FIG. 5.

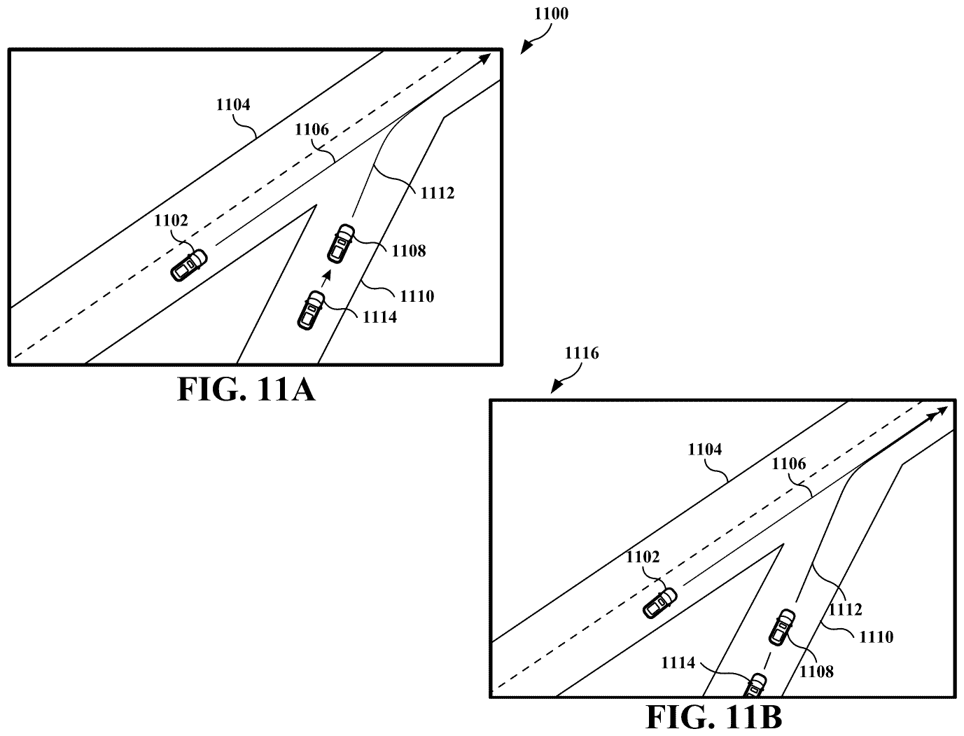

Predicted locations of each of the leading vehicle 606 and the trailing vehicle 608 are added to the occupancy grid 612. Locations labeled (1), such as a location 616, correspond to the predicted locations of the leading vehicle 606; and locations labeled (2), such as a location 618, correspond to the predicted locations of the trailing vehicle 608. A respective buffer distance is then added with respect to each of the predicted locations. The calculations of the buffer distances are further described below. The buffer distances are considered to be constraints on the locations of the AV during the search for the tactical speed plan. Said another way, the buffer distances can be considered to correspond to prohibited locations of the AV when searching for the tactical speed plan. To illustrate, a buffer distance 620 is added corresponding to the location 616; and a buffer distance 622 is added corresponding to the location 618. In all figures, buffer distances are those areas filled with a pattern 628. Buffer distances are shown as being in front of and behind world objects added to the occupancy grid. The buffer distance ahead of a leading vehicle can be used in cases where a vehicle may be merging into the AV lane (such as in the case where the AV may be making a left turn at an unprotected intersection). In such cases, the buffer distance can be used to determine whether there is enough distance for the AV to be (e.g., to fit) ahead of the merging vehicle. This scenario, while not specifically described as such, is illustrated with respect to FIG. 11A where the AV 1102 will merge in front of the second along path vehicle 1114.

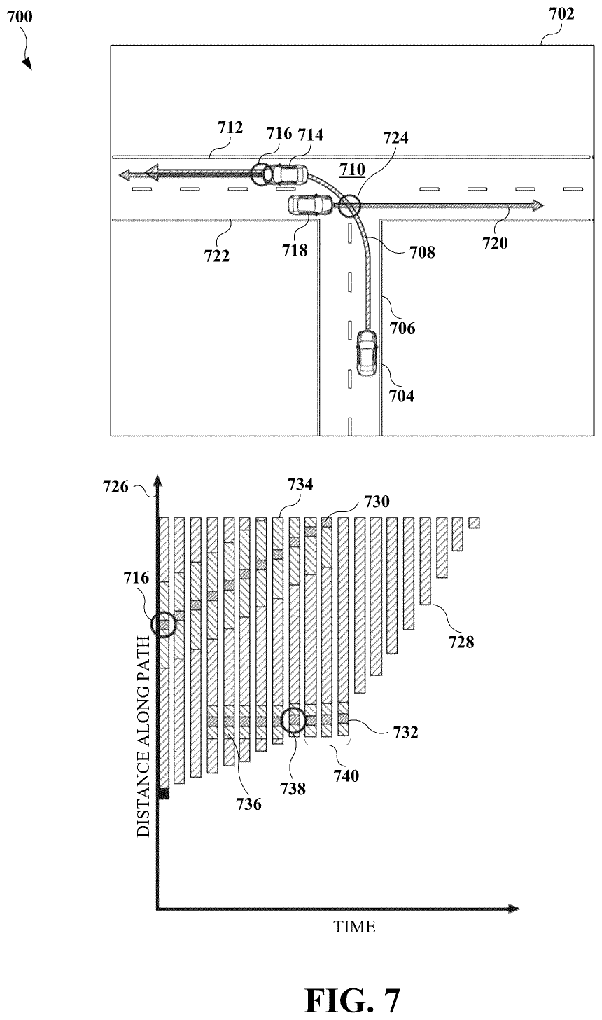

FIG. 7 illustrates another example 700 of adding world objects to an occupancy grid. A scene 702 illustrates that an AV 704 is traveling on a lane 706 along a planned path 708 (i.e., according to a strategic speed plan) towards a T-intersection 710 where the AV 704 is planned to turn left heading westward on a lane 712. The scene 702 also includes an along path vehicle 714 that is also predicted to be traveling on the lane 712. The along path vehicle 714 is initially observed to be at a location 716. The scene 702 also includes a crossing vehicle 718. The crossing vehicle 718 is predicted to be traveling eastward along a path 720 on a lane 722. The paths of the AV 704 and the crossing vehicle 718 are predicted to intersect at a location 724.

An occupancy grid 726 has been generated and includes upper limits, as described above. As such, a vertical bar 728 can be similar to the vertical bar 518 of FIG. 5. Predicted locations (such as a location 730) of the along path vehicle 714 are added to the occupancy grid 726; and locations (such as a location 732) of the crossing vehicle 718 are added to the occupancy grid 726. The locations of the crossing vehicle 718 are not based on a predicted path, over time, of the crossing vehicle 718. Rather, and as can be observed in the occupancy grid 726, the crossing vehicle 718 appears to be stationary over time. As the crossing vehicle 718 briefly crosses the path of the AV 704, the locations are time-based (as opposed to being distance based as for along world objects). The location of the crossing vehicle 718 is the location of intersection (here, the location 724).

Buffer distances, such as buffer distances 734 and 736, are then added with respect to the locations. In the occupancy grid 726, a location 738 corresponds to the location 724 (i.e., the intersection). The occupancy grid can include additional (e.g., extra) buffer times 740 for after the crossing vehicle 718 passes the AV 704 as an additional safety measure, just in case the crossing vehicle 718, for example, stalls.

Buffer distances for along path world objects are set (e.g., calculated, configured, selected, etc.) based on time headway (THW), such as using equation (1); and buffer distances for crossing world objects are set based on time-to-collision (TTC), such as using equation (2).

$$THW = min ( 1.6 - ( vel - 14 ) * 0.033 , 1 \text{.3} ) \qquad ( 1 )$$

$$TTC = \frac{{v}_{x i n g}}{6} + 1.5 \qquad ( 2 )$$

In equation (1), vel is the velocity of the AV 704, 1.3 seconds and 1.6 seconds indicate, respectively, the minimum time headway and the maximum time headway; and 14 represents a speed of 14 meters per second. Equation (1) is essentially a linear equation that can interpreted relative to the velocity vel of the AV 704. The faster the AV 704 is traveling, the AV 704 will eventually reach 1.3 seconds for the THW; and the slower the AV 704 is traveling, the AV 704 will stay at 1.6 seconds for the THW. Equation (1) (i.e., the values 1.6, 1.3, 14, and 0.033 used therein) is empirically derived and has been found to result in a comfortable result (e.g., ride) during testing. As is known, THW is the time interval between two vehicles passing a specific point on a roadway, typically measured from the front of one vehicle to the front of the following vehicle.

In equation (2), v_{xing} is the observed speed the crossing vehicle. Equation (2) sets out a minimum required time that is comfortable for the crossing vehicle 718 to allow the AV 704 to pass it or for the AV 704 to wait for the crossing vehicle 718 to pass the AV 704 first, specifically at intersections.

Referring again to FIG. 4, at 406, a virtual lead vehicle is added to the occupancy grid, if necessary (e.g., based on blocked visibility). When virtual predictions (i.e., predicted path or locations of a virtual world object) intersect with the path of the AV, special “virtual” lead vehicles are created (e.g., added to the occupancy grid) to produce an edging effect, causing the AV to slowly inch through the beginning of an intersection for more visibility. This “virtual” lead vehicle disappears (e.g., is removed from the occupancy grid) when visibility becomes possible.

To illustrate, if the AV is turning left at an intersection and the lane onto which the AV is planned to turn is occluded, then a virtual crossing vehicle may be placed close to (e.g., at) a last location on the lane that is observable by sensors of the AV along its path. As further described herein, a virtual lead vehicle is added to the occupancy grid to induce (e.g., cause or generate) an edging motion by the AV towards the intersection. More generally, other types of virtual vehicles can be added, as necessary, depending on the road geometry.

A virtual vehicle is one that does not in fact exist in the scene (e.g., the world 302 of FIG. 3) and is not one that is perceived by the perception tool 306 of FIG. 3. Virtual vehicles may be added to the world model maintained by the world model prediction tool 308 of FIG. 3 in cases where portions of a road are occluded, such as when driving around tight corners and/or driving in limited visibility environments (e.g., on a foggy day or a lane is not completely visible) or in anticipation of vehicles unexpectedly appearing. Virtual vehicles are added to the world model in occluded regions of a road (e.g., a lane therein) or at a maximum perception range. The edging motion allows the AV to slowly gain more visibility of the scene while maintaining the ability to stop for real vehicles that may appear and are not currently perceptible by sensors on the AV. The edging motion contributes to the process of crossing unprotected intersections with limited visibility. Whereas the buffer distances for real (e.g., observed or sensed) along path world objects are calculated as described above with respect to equation (1), the THW with respect to a virtual lead vehicle can be set to a small constant (e.g., 0.5 seconds) so that a close following distance can be maintained.

At 408, an estimated speed plan (e.g., a short-term or tactical speed plan) for the planning window is determined (e.g., searched, calculated, identified, found, etc.) based on the occupancy grid. That is, after all relevant world objects are included into the occupancy grid, a search algorithm (e.g., the A* search algorithm) searches for the estimated, quickest path from a current AV position (e.g., a start position, such as a current position 624 of FIG. 6) to the upper right-hand corner (e.g., a goal position, such as a position 626 of FIG. 6) representing the farthest distance in the planning window. The result of A* is an estimated speed plan that is then used to formulate constraints in the optimization problem that generates the real speed plan (e.g., the short-term speed plan) used. As already mentioned, the estimated speed plan may be, in fact, a set of distance values at discrete time steps.

A conventional occupancy grid breaks a space down into cells represented in the occupancy grid based on their x and y coordinates; and a conventional A* search is performed in this two-dimensional space based on which cells are occupied or are otherwise unavailable. However, the occupancy grid described herein includes time on the horizontal axis and distance on the vertical axis. The occupancy grids described herein convey information such as: at 50 meters along the path of the AV and 3 seconds from now, that location will be occupied and the AV cannot be allowed to be at that location. The A* search algorithm can be thought of as a variant of the conventional A* search and uses a heuristic that follows the strategic plan as closely as possible to estimate distances along the path of the AV vs. time. For example, the strategic speed plan, world model objects, and their relative time headways all represent occupied spaces in the occupancy grid. The occupancy grid indicates to the A* search algorithm the spaces that the AV cannot occupy. To further clarify, everything plotted on the occupancy grid at this point (e.g., strategic speed plan, world objects, THWs) represent an occupied space. To perform the search, at least the following operations are performed: lead vehicles are identified, the strategic speed plan is obtained, and the occupancy grid is generated.

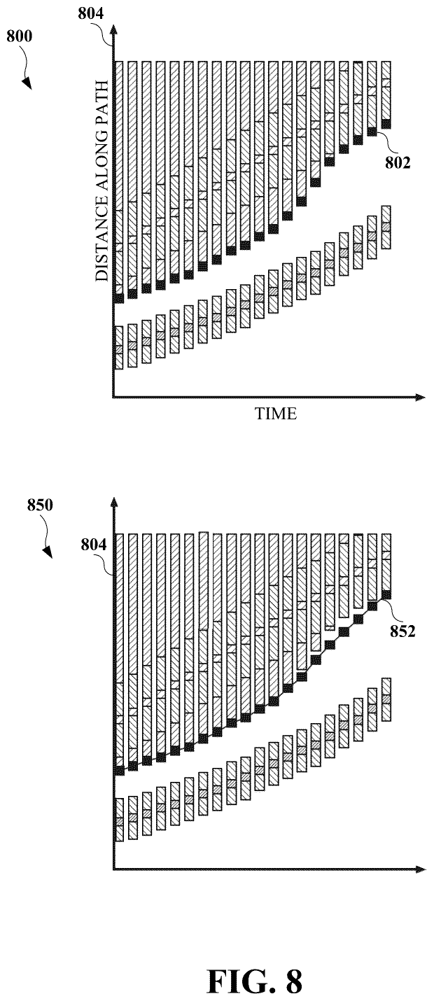

Referring again to FIG. 4, the estimated short-term speed plan may be smoothed at 410. A path smoothing interpolation algorithm can be applied to the estimated predicted values of the AV therewith resulting in a more realistic (and smoother) speed plan. FIG. 8 illustrates an example 800 of an estimated speed plan and an example 850 of a smoothed estimated speed plan (i.e., a smoothed path). The estimated speed plan illustrated in the example 800 is obtained at 408 and includes a set of locations (shown as black-filled squares), such as a location 802, shown on an occupancy grid 804. A smoothed estimated speed plan (i.e., a smooth curve 852) illustrates the results of the smoothing of the estimated speed plan (or, simply, the smoothed speed plan). Again, the estimated (or smoothed) speed plan consists of, e.g., distance values at discrete time steps.

In some cases, the OSP checks whether the smoothed speed plan results in the AV having to be stopped inside (e.g., in the middle) of an intersection at any point in time within the planning window. If not, then the AV is controlled to proceed according to the speed plan (i.e., the smoothed speed plan). On the other hand, if the AV is planned to be stopped in the middle of an intersection, then a virtual stop line is created at the beginning of the intersection preventing the AV from entering until a clear path from the start to end of the intersection is detected (e.g., identified, calculated, planned, etc.). The beginning and the ending of an intersection can be identified based on (e.g., obtained from) a map (e.g., a high-definition map).

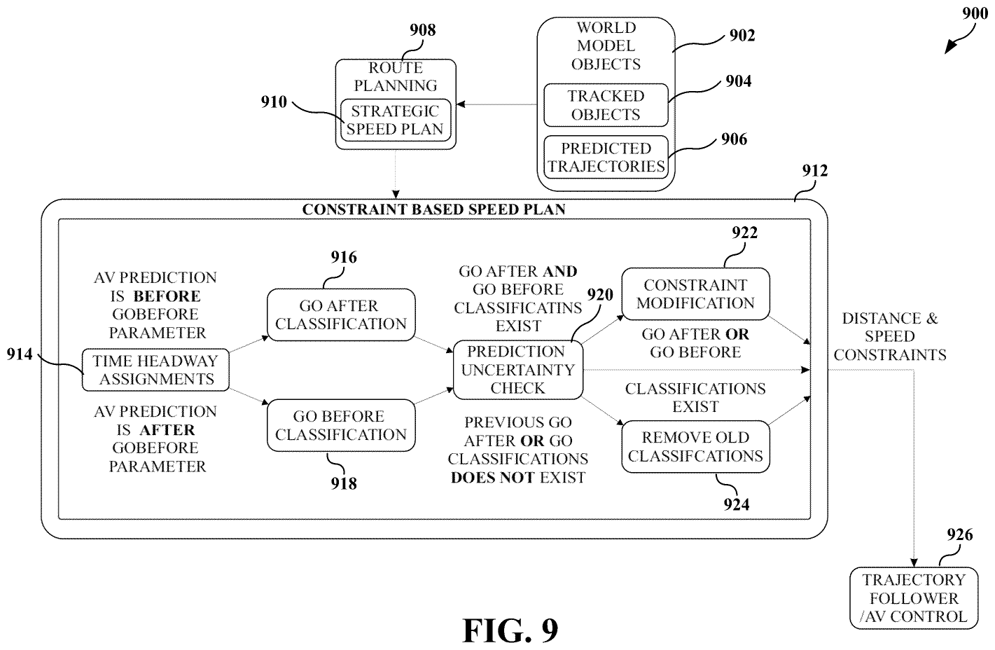

At 412 of FIG. 4, the OSP detects and/or mitigates scenarios involving merging and/or crossing vehicles. In some cases, detection of merging and/or crossing vehicles and/or mitigation associated therewith may be performed as part of step 404 (in addition to step 412 or in lieu of step 412). Detection and/or mitigation of merging and/or crossing vehicles is described in further detail in connection with FIGS. 9-16, below.

FIG. 9 is a process flow 900 that illustrates an example of a process for using merge detection and mitigation for generating a constraint-based speed plan. The process flow 900 may be implemented as part of an AV control system to enable safe and efficient navigation in complex traffic scenarios, particularly those involving merging and crossing vehicles.

The process flow 900 begins with world model objects 902 and tracked objects 904, which may represent the current state of the environment around the AV. These objects may include other vehicles, pedestrians, cyclists, and static obstacles detected by the AV's sensors. In some implementations, the world model objects 902 may be continuously updated based on new sensor data, while the tracked objects 904 may represent objects that have been consistently observed over a period of time.

Predicted trajectories 906 may be generated based on the world model objects 902 and tracked objects 904. These predicted trajectories 906 may represent the expected future positions and movements of other road users and objects in the environment. In some aspects, multiple possible trajectories may be generated for each object, with associated probabilities, to account for uncertainty in the predictions.

The process flow 900 may include a route planning component 908 that generates a strategic speed plan 910. The strategic speed plan 910 may represent an initial plan for the AV's movement, taking into account factors such as the desired route, road geometry, and traffic rules. In some implementations, the strategic speed plan 910 may be generated without considering the dynamic obstacles in the environment, serving as a baseline plan that will be refined in subsequent steps.

The constraint-based speed plan component 912 may take inputs from various sources, including the strategic speed plan 910 and the predicted trajectories 906, to generate a refined speed plan that accounts for the dynamic environment around the AV. One operation of the constraint-based speed plan component 912 may be the time headway assignments 914. This operation may determine appropriate time headways for the AV with respect to other vehicles, which may be used to maintain safe following distances and create opportunities for merging or lane changes. The time headway assignments 914 may feed into both a go after classification component 916 and a go before classification component 918.

The go after classification component 916 and go before classification component 918 may work together to respective classify other vehicles in the environment as either a vehicle the AV should follow behind or a vehicle the AV can safely move in front of. These classifications may be used for determining the AV's behavior in merging and intersection scenarios. In some implementations, the classification may be based on factors such as relative speeds, distances, and predicted trajectories of the vehicles involved.

A prediction uncertainty check component 920 may interact with the classification components or modules to account for uncertainty in the predicted trajectories of other vehicles. The prediction uncertainty check component 920 may help ensure that the AV's decisions are robust to potential variations in the behavior of other road users. In some aspects, the prediction uncertainty check component 920 may adjust the classifications or add additional constraints to the speed plan based on the level of uncertainty in the predictions.

The constraint modification component 922 may receive input from the classification and uncertainty check components to modify the constraints used in generating the final speed plan. This component may adjust constraints based on the current traffic situation, the progress of the AV progress along its route, and any changes in the classifications of other vehicles. In some implementations, the constraint modification component 922 may also remove old classifications 924 that are no longer relevant to the current situation.

The output of the constraint-based speed plan component 912 may be sent to a trajectory follower component 926, which may control the AV to execute the generated speed plan. The trajectory follower component 926 may translate the speed plan into specific control commands for the actuators of the AV, ensuring that the vehicle follows the planned trajectory as closely as possible while maintaining safety and comfort for any passengers. In some aspects, the process flow 900 may operate in a continuous loop, constantly updating the speed plan based on new sensor data and changes in the environment. This iterative approach may allow the AV to adapt to dynamic traffic situations and maintain safe and efficient operation in a wide range of scenarios.

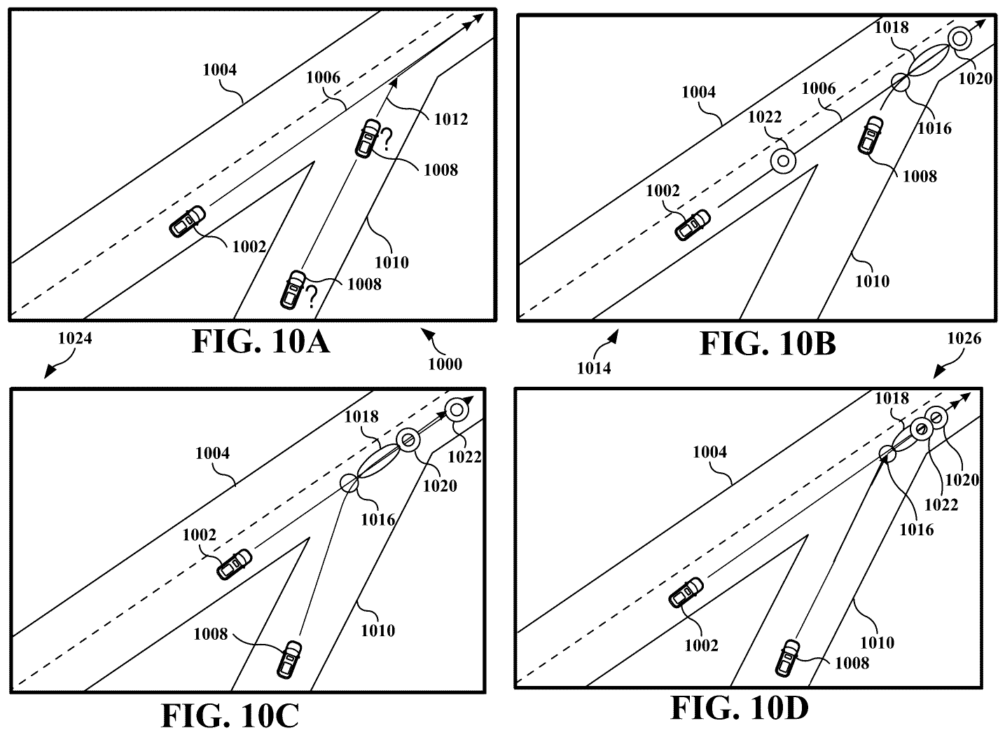

FIGS. 10A-10D illustrate examples associated with classifying an other road user (ORU) vehicle as a Go Before vehicle or a Go After vehicle. These figures depict various scenarios and calculations used in the decision-making process for an AV when interacting with other vehicles on the road.

FIG. 10A shows an example 1000 of a road scenario where an AV 1002 is traveling on a first road 1004 along an AV path 1006. An ORU vehicle 1008 is shown on a second road 1010, following a predicted ORU path 1012 that intersects with the AV path 1006. This scenario may represent a typical intersection or merging situation that the AV may encounter. For merging scenarios on faster roads where ORU vehicles are merging into the lane in which the AV 1002 is traveling, the AV 1002 may adjust its speed to appropriately navigate traffic by deciding to go before, after, or in between vehicles. To do so, the AV 1002 may classify and react to ORU vehicles merging into its lane. A merging vehicle may be defined as a vehicle with a predicted path that interacts with the path of the AV in the future. In some implementations, a merging vehicle may be an ORU vehicle that is predicted to interact with the path in the future but is currently not in the lane in which the AV is traveling. In some implementations, a bounding box may be used to define an area associated with classifying merging vehicles. In some implementations, to classify a vehicle as a merging vehicle, the predicted ORU path may have to satisfy a threshold. For example, an ORU vehicle may be classified as a merging vehicle based on a predicted ORU path being within a threshold lateral distance (e.g., 2 meters) of the AV path.

FIG. 10B illustrates an example 1014 associated with a Go After classification. The AV 1002 may determine an ORU distance 1016, which represents a predicted distance the ORU vehicle 1008 will travel along its path by the time of interaction (referred to interchangeably as “timeOfInteraction”), t, with the AV 1002. The AV 1002 also may determine a safety distance 1018, which may be calculated based on the predicted velocity of the ORU vehicle and a time headway parameter. The safety distance 1018 may be determined as vel_{ORU,t}*τ_{safety}, where vel_{ORU,t} is the velocity of the ORU vehicle 1008 and τ_{safety} is the time headway parameter. The safety distance may be a distance by which the AV 1002 is to be ahead of the ORU at the time of interaction, t (e.g., τ=1 s, vel=20 m/s, safety distance=20 m).

The check distance 1020 is then calculated by adding the ORU distance 1016 and the safety distance 1018:

$$checkDist = {dist}_{ORU , t} + {dist}_{ORU , t} * {τ}_{safety} . \qquad ( 3 )$$

The check distance 1020 serves as a threshold for determining whether the AV 1002 should go before or after the ORU vehicle 1008. The AV distance 1022 represents a predicted distance the AV 1002 will travel along its path by the time of interaction. For example, if the AV distance 1022 is less than the check distance 1020, the AV 1002 may classify the ORU vehicle as a Go After vehicle and may slow down accordingly.

FIG. 10C illustrates an example 1024 associated with a Go Before classification. Go Before classification operations may use the same equation used to classify a Go After vehicle, where the predicted AV path is ahead of the predicted ORU path and the AV 1002 will continue at the same speed or even accelerate to pass the Go Before vehicle 1008:

$$t = timeOfInteraction$$

$$checkDist = {dist}_{O RU , t} + {vel}_{O RU , t} * {τ}_{safety} \qquad ( 4 )$$

$${checkDist}_{t} < {AvDist}_{t} \qquad ( 5 )$$

where vel_{ORU,t}*τ_{safety} is a safety distance. The time headway, τ_{safety}, may include any number of different values. In some implementations, the time headway may range between 0.1 to 1.6 s depending on factors such as relative velocity.

FIGS. 10B and 10C above show two examples, 1014 and 1024, illustrating different classification outcomes based on the relative positions of the AV 1002 and ORU vehicle 1008. In example 1024, the AV distance 1022 is less than the check distance 1020, resulting in the ORU vehicle 1008 being classified as a “Go After” vehicle. This means the AV 1002 should plan to pass through the intersection or merge point after the ORU vehicle 1008 has passed. Conversely, in example 1026, the AV distance 1022 is greater than the check distance 1020, resulting in the ORU vehicle 1008 being classified as a “Go Before” vehicle. In this case, the AV 1002 may plan to pass through the intersection or merge point before the ORU vehicle 1008 arrives.

FIG. 10D shows an example 1026 in which the check distance 1020 is slightly ahead of the AV distance 1022 prediction. In some implementations, speed conditions may be utilized for facilitating decision-making in such situations. For example, in some implementations, if the check distance 1020 is slightly ahead of the AV distance 1022 prediction and the AV 1002 satisfies one or more speed conditions, the ORU vehicle 1008 may be classified as a Go Before vehicle and the AV 1002 may accelerate slightly to get ahead of it. In some cases, for example, the one or more speed conditions may include a condition in which a velocity of the AV 1002 is close to that of the ORU vehicle 1008. In some implementations, whether the AV 1002 satisfies a speed condition may include determining a speed parameter (“speedParam”), a speed difference (“speedDiff”) between the AV 1002 and the ORU vehicle 1008, and a current behind time headway (“currBehindTimeHeadway”) as follows:

$$speedParam = max ( - 3 , min ( - 1 , ( - 1 + {vel}_{AV , t} - 11 ) * ( 0.222 ) ) ; \qquad ( 6 )$$

$$speedDiff = {vel}_{AV , t} - {vel}_{ORU , t} ; and \qquad ( 7 )$$

$$currBehindTimeHeadway = ( {dist}_{AV , t} - {dist}_{ORU , t} ) / {vel}_{ORU , t} , \qquad ( 8 )$$

where the AV 1002 may be determined to satisfy the speed condition based on a determination that:

$$speedParam < speedDiff and 0.15 < currBehindTimeHeadway . \qquad ( 9 )$$

FIGS. 11A and 11B illustrate examples associated with classifying multiple ORU vehicles as Go Before vehicles and/or Go After vehicles.

FIG. 11A shows an example 1100 of a road scenario where an AV 1102 is traveling on a first road 1104 along an AV path 1106. A first ORU vehicle 1108 is shown on a second road 1110, following a first predicted ORU path 1112 that intersects with the AV path 1106. Additionally, a second ORU vehicle 1114 is present on the second road 1110, following behind the first ORU vehicle 1108. This scenario may represent a typical situation where the AV 1102 needs to merge into or cross a lane with multiple vehicles.

In this example, the AV 1102 may need to classify both the first ORU vehicle 1108 and the second ORU vehicle 1114 to determine the appropriate action. The classification process may be similar to that described for a single ORU vehicle, but with additional considerations for the interaction between multiple vehicles.

For the first ORU vehicle 1108, the AV 1102 may determine a first check distance using the equation:

$${checkDist}_{1} = {dist}_{ORU 1 , t} + {vel}_{ORU 1 , t} {τ}_{safety} , \qquad ( 10 )$$

where dist_{ORU1,t} is the predicted distance of the first ORU vehicle 1108 at the time of interaction t, vel_{ORU1,t} is its predicted velocity, and τ_{safety} is the safety time headway parameter. Similarly, for the second ORU vehicle 1114, the AV 1102 may calculate a second check distance:

$${checkDist}_{2} = {dist}_{ORU 2 , t} + v e {l}_{ORU 2 , t} {τ}_{safety} . \qquad ( 11 )$$

The AV 1102 may then compare its own predicted distance (AV Distt) at the time of interaction with both check distances to classify the ORU vehicles 1108 and 1114.

FIG. 11B illustrates an example 1116 where the AV 1102 has classified the first ORU vehicle 1108 as a Go Before vehicle and the second ORU vehicle 1114 as a Go After vehicle. This classification may occur when:

$${AVDist}_{t} > {checkDist}_{1} and {AVDist}_{t} < {checkDist}_{2} . \qquad ( 12 )$$

In this case, the AV 1102 may plan to merge or cross between the two ORU vehicles 1108 and 1114. In some implementations, the AV 1102 may also consider the gap between the two ORU vehicles 1108 and 1114 to ensure there is sufficient space to safely execute the maneuver. This gap may be calculated as:

$$gap = {dist}_{ORU 2 , t} - {dist}_{ORU 1 , t} - {vehicleLength}_{ORU 1} , \qquad ( 13 )$$

where vehicleLength_{ORU1} is the length of the first ORU vehicle 1108. The AV 1102 may compare this gap to a minimum safe gap threshold (minSafeGap) to determine if merging between the vehicles is feasible such that if gap>minSafeGap, the AV 1102 may merge between the ORU vehicles 1108 and 1114 and otherwise, the AV may consider reclassification or waiting for a next opportunity to merge.

In some aspects, the minSafeGap may be dynamically adjusted based on factors such as the relative velocities of the vehicles, road conditions, or the capabilities of the AV.

In some implementations, the AV 1102 may use probabilistic models to account for uncertainty in the predicted paths and velocities of the ORU vehicles. This may involve calculating confidence intervals for the check distances and using these to make more robust classifications. In some implementations, the AV 1102 may also consider the behavior of the ORU vehicles over time. For instance, if the second ORU vehicle 1114 is observed to be accelerating, the AV 1102 may adjust its classification or decision-making process accordingly. This may involve using time-series data and prediction algorithms to estimate future states of the ORU vehicles. The system may also incorporate machine learning techniques to improve its classification and decision-making processes over time. By analyzing the outcomes of previous interactions with multiple ORU vehicles, the system may learn to make more accurate and safer decisions in complex traffic scenarios.

In cases where the classification of multiple ORU vehicles results in conflicting constraints (e.g., unable to go before one vehicle while going behind another), the system may implement a conflict resolution strategy. This may involve prioritizing certain constraints, re-planning the path of the AV, or deciding to wait for a clearer opportunity.

In AV navigation, predicting the behavior of merging vehicles is used for safe and efficient operation. However, these predictions are inherently uncertain due to the complex and dynamic nature of traffic scenarios. The system may account for this uncertainty to make more robust decisions and adapt to changing situations in real-time.

In some implementations, an uncertainty value may be assigned to each merging vehicle based on how closely the merging vehicle follows its predicted acceleration. The system may track the acceleration of merging vehicles over time to determine the accuracy of the prediction. The uncertainty value associated with a merging vehicle may be determined based on calculating the difference between the measured acceleration of the merging vehicle and the predicted acceleration of the merging vehicle:

$${acc}_{diff} = \vert {a}_{tracked} - {acc}_{predicted} \vert \qquad ( 14 )$$

where acc_{diff} is the difference between measured and predicted acceleration, a_{tracked} is the measured acceleration of the merging vehicle, and acc_{predicted} is the predicted acceleration of the merging vehicle. The predicted acceleration of the merging vehicle may be predicted based on a an acceleration profile determined as part of the world model. The uncertainty value may be assigned based on acc_{diff} and may range between 0 and 1.

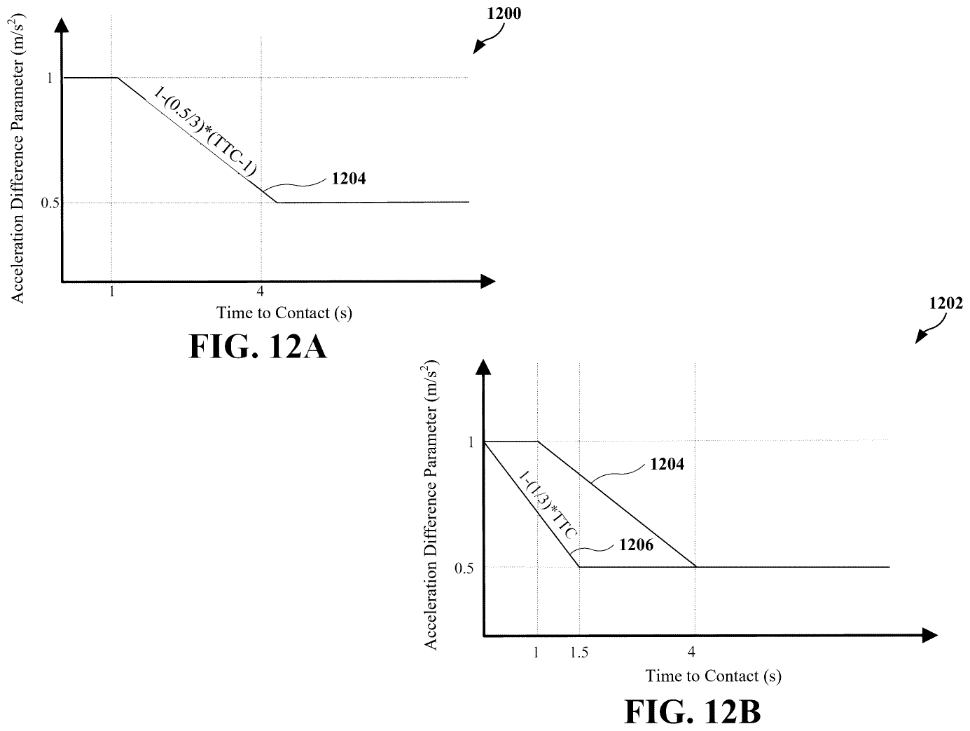

This process may involve using an acceleration difference parameter to estimate how large the discrepancy between measured acceleration and predicted acceleration can be before the discrepancy is deemed to be uncertain. FIGS. 12A and 12B illustrate graphs 1200 and 1202 associated with two respective acceleration difference parameters.

FIG. 12A illustrates a graph 1200 showing a first acceleration difference parameter as a first function 1204 of a time to contact value. The time to contact value represents the time when the predicted path of the merging vehicle meets the predicted path of the AV. As shown, the acceleration parameter may increase as the time to contact decreases, representing that the ORU will be in the lane very soon, and that its classification is therefore unlikely to change at the last second. As shown, the first acceleration difference parameter value may be represented as:

$${param}_{acc} = 1 - ( 0.5 / 3 ) * ( T T C - 1 ) , \qquad ( 15 )$$

where param_{acc} is the acceleration difference parameter and TTC is the time to contact.

The AV may compare the difference between the measured and predicted acceleration of the merging vehicle with the acceleration difference parameter to determine a new uncertainty value. In some implementations, the new uncertainty value may be updated based on the following conditions:

$$1. If {acc}_{diff} < {param}_{a c c} ( representing a small discrepancy ) :$$

$$newUncertainty = max ( 0 , 0.95 * currUncertainly - 0.05 ( 0.1 / {acc}_{diff} ) ; \qquad ( 16 )$$

$$and$$

$$2. If {acc}_{diff} >= {param}_{acc} ( representing a larger discrepancy ) :$$

$$newUncertainty = min ( 1 , 0.9 * currUncertainty + 0.1 * {acc}_{diff} ) , \qquad ( 17 )$$

where newUncertainty is the updated uncertainty value, currUncertainty is the current uncertainty value, and param_{acc} is the acceleration difference parameter.

In some implementations, if the uncertainty value passes a threshold and certain speed conditions between the AV and the ORU vehicle are met, the classification of the ORU vehicle may be switched to the opposite (i.e., from Go After to Go Before and vice versa). The acceleration difference parameter equation may become more conservative when the vehicle is more uncertain. FIG. 12B is a graph 1202 showing a second acceleration difference parameter as a second function 1206 of the time to contact value. FIG. 12B also shows the first function 1204 to illustrate the difference between the two acceleration difference parameters. As shown, the second acceleration difference parameter value may be represented as:

$${param}_{acc} = 1 - ( 1 / 3 ) * ( TTC - 1 ) , \qquad ( 18 )$$

where param_{acc} is the acceleration difference parameter and TTC is the time to contact. The speed conditions for switching classifications may be defined as follows:

$$1. For switching from Go after to Go Before :$$

$$speedParam = max ( 7 , max ( 3 , ( 3 + {vel}_{AV} - 11 ) * ( 0.4 \; 44 ) ) , \qquad ( 19 )$$

$$speedDiff = {vel}_{AV} - {vel}_{ORU} , and \qquad ( 20 )$$

If speedParam<speedDiff and acc_{ORU}<0.75, the classification may be switched. This condition may indicate that the AV must be going relatively faster, and the ORU vehicle should not be accelerating very quickly.

$$2. For switching from Go Before to Go After :$$

$$speedParam = max ( - 5 , max ( - 3 , ( - 3 + {vel}_{AV} - 11 ) * ( 0.2 \; 22 ) ) , \qquad ( 21 )$$

$$speedDiff = {vel}_{AV} - {vel}_{ORU} , and \qquad ( 22 )$$

if speedParam<speedDiff and acc_{ORU}>0.75, the classification may be switched. This condition may indicate that the AV must be going relatively slower, and the ORU vehicle should be accelerating.

In some implementations, the system may use machine learning techniques to improve the accuracy of uncertainty estimation over time. For example, a neural network may be trained on historical data to predict the likelihood of classification changes based on various factors such as vehicle trajectories, road conditions, and traffic patterns. Alternative embodiments may incorporate additional sensors or data sources to refine uncertainty estimates. For instance, vehicle-to-vehicle (V2V) communication may provide more accurate information about the intentions and capabilities of nearby vehicles, potentially reducing uncertainty in classification decisions. The system may also employ probabilistic methods, such as Bayesian inference, to update uncertainty estimates continuously as new information becomes available. This approach may allow for more nuanced decision-making that accounts for the confidence level in each classification. In some aspects, the system may use the uncertainty analysis to implement a multi-modal planning approach. Instead of committing to a single classification, the AV may generate multiple potential trajectories based on different possible outcomes, weighted by their respective probabilities. This may enable the AV to respond more quickly and smoothly to unexpected changes in the behavior of ORU vehicles.

By incorporating uncertainty analysis into the classification process, as illustrated in FIGS. 12A and 12B, the autonomous vehicle may make more robust and adaptable decisions when navigating complex traffic scenarios. This approach may enhance safety, improve traffic flow, and provide a more comfortable experience for passengers by reducing the need for sudden changes in velocity or direction.

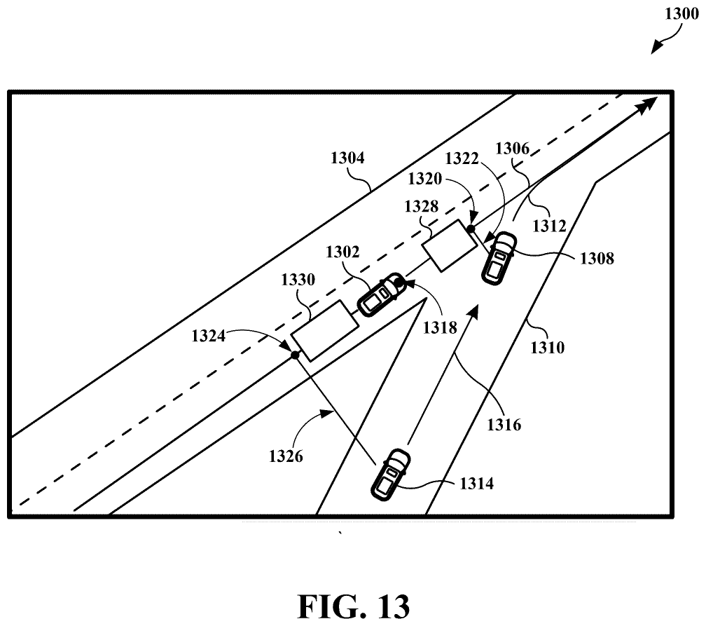

FIG. 13 illustrates an example 1300 associated with constraint modification for merging onto a road. The figure depicts a scenario where an AV 1302 is traveling on a first road 1304 along an AV path 1306. The AV 1302 encounters a situation where it needs to merge between two ORU vehicles—a first ORU vehicle 1308 and a second ORU vehicle 1314. In this scenario, the first ORU vehicle 1308 is traveling on a second road 1310 following a first predicted ORU path 1312. The second ORU vehicle 1314 is also on the second road 1310, following a second predicted ORU path 1316. The AV 1302 needs to merge onto the second road 1310 between these two ORU vehicles.

The AV 1302 may classify the first ORU vehicle 1308 as a Go Before vehicle and the second ORU vehicle 1314 as a Go After vehicle. This classification creates a “window” between the two ORU vehicles through which the AV 1302 must navigate to safely complete the merge. To determine the appropriate speed and trajectory for merging, the AV 1302 may use the predicted distances of the Go Before and Go After vehicles at the time of interaction, t. These distances are represented as dist_{GB,t} for the Go Before vehicle (first ORU vehicle 1308) and dist_{GA,t} for the Go After vehicle (second ORU vehicle 1314).

The AV 1302 may calculate a midpoint 1318 between the two ORU vehicles using the following equation:

$$midpoint = ( {dist}_{GA , t} + {dist}_{GB , t} ) / 2 , \qquad ( 23 )$$

where t is the time at which the Go Before vehicle first interacts with the AV path. This midpoint 1318 serves as a reference point for determining the appropriate time headways for both ORU vehicles, which in turn are used to create upper and lower bound constraints for the speed and position of the AV. For the Go Before vehicle (first ORU vehicle 1308), the AV 1302 may calculate a Go Before time headway (goBeforeTHW) using the following equation:

$$goBeforeTHW = min ( {τ}_{G B} , max ( 0.1 , \frac{midpoint - 5 - {dist}_{GB , t}}{{vel}_{G B}} ) ) , \qquad ( 24 )$$

where TGB is a predefined maximum time headway for Go Before vehicles, vel_{GB} is the velocity of the Go Before vehicle, and 5 is a constant that may represent, for example, a safety buffer distance. Similarly, for the Go After vehicle (second ORU vehicle 1314), the AV 1302 may calculate a Go After time headway (goAfterTHW) using the following equation:

$$goAfterTHW = min ( {τ}_{G A} , max ( 0.2 , \frac{{dist}_{GA , t} - midpoint + 5}{{mel}_{A V}} ) ) , \qquad ( 25 )$$

where τ_{GA} is a predefined maximum time headway for Go After vehicles, vel_{AV} is the velocity of the AV 1302, and 5 is again a constant such as, for example, a safety buffer distance.

These time headways are then used to create upper and lower bound constraints for the AV trajectory. The upper bound constraint 1328 is based on the Go Before time headway, ensuring that the AV 1302 maintains a safe distance behind the first ORU vehicle 1308. The lower bound constraint 1330 is based on the Go After time headway, ensuring that the AV 1302 maintains a safe distance ahead of the second ORU vehicle 1314. The AV 1302 may use these constraints to adjust its speed and position, creating enough distance between the two ORU vehicles to safely merge. This may involve accelerating or decelerating as needed to fit within the “window” created by the upper and lower bound constraints.

In some implementations, the AV 1302 may continuously update these calculations as the AV 1302 approaches the merge point, adjusting its trajectory based on any changes in the positions or velocities of the ORU vehicles. This dynamic approach allows the AV 1302 to adapt to changing traffic conditions in real-time. Some implementations may incorporate additional factors into the constraint calculations. For example, the AV 1302 may consider road conditions, weather, or the specific capabilities of the AV 1302 when determining appropriate time headways and safety buffers. The AV 1302 may also use machine learning techniques to refine its constraint calculations over time, learning from successful and unsuccessful merge attempts to improve its decision-making process. In some cases, the AV 1302 may determine that a safe merge is not possible given the current positions and velocities of the ORU vehicles. In such situations, the AV 1302 may choose to abort the merge attempt and wait for a more favorable opportunity, or it may adjust its route to find an alternative merge point.

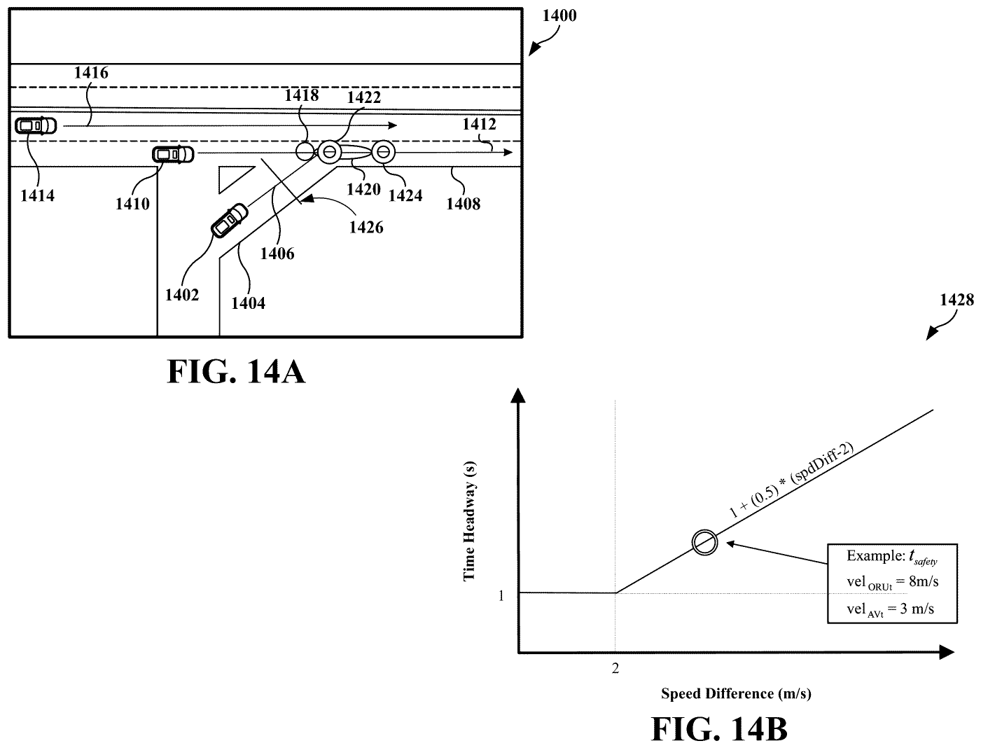

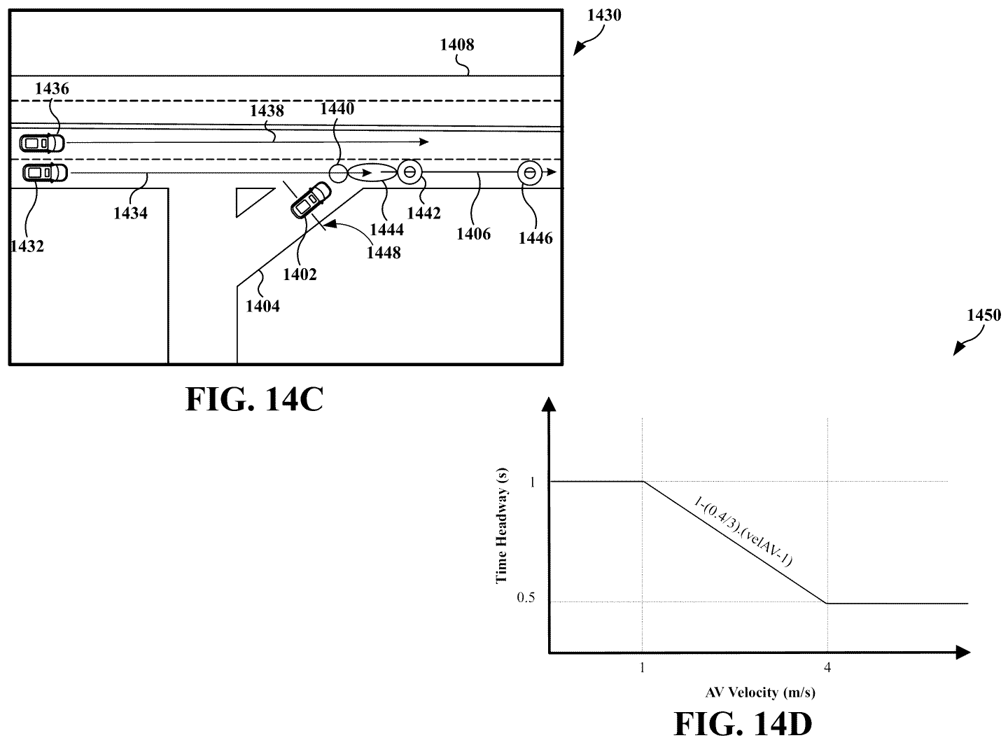

FIGS. 14A-14D illustrate examples associated with classifying crossing ORU vehicles as Go Before vehicles and/or Go After vehicles. For example, FIGS. 14A-14D illustrate examples associated with merging from a slower road onto a faster road. These figures depict various scenarios and calculations used in the decision-making process for an AV when merging onto a major road from a minor road.

FIG. 14A shows an example 1400 of a road scenario where an AV 1402 is traveling on a first road 1404 (minor road) along an AV path 1406. The AV 1402 is approaching a second road 1408 (major road) where the AV 1402 needs to merge. Two ORU vehicles, 1410 and 1414, are shown on the second road 1408, following predicted ORU paths 1412 and 1416, respectively. In this scenario, the AV 1402 may use the same merging classification algorithm as described earlier to determine whether an ORU vehicle should be classified as a Go After or Go Before vehicle. However, because the AV 1402 is merging from a minor road onto a major road, it must yield to the road users on the major road. As a result, the time headway parameter used for Go Before classifications may be more conservative in this situation.

FIG. 14B is a graph 1428 that illustrates how the more conservative time headway produces a further check distance. The AV 1402 may determine an ORU distance 1418, which represents the predicted distance the ORU vehicle 1410 will travel along its path by the time of interaction with the AV 1402. The AV 1402 also may determine a safety distance 1420, which may be calculated based on the predicted velocity of the ORU vehicle and the conservative time headway parameter. The safety distance 1420 may be determined as:

$$SafetyDist = {vel}_{ORU , t} * {τ}_{safety} , \qquad ( 26 )$$

where vel_{ORU,t} is the predicted velocity of the ORU vehicle 1410 at the time of interaction and τ_{safety} is the conservative time headway parameter. The check distance 1424 is then calculated by adding the ORU distance 1418 and the safety distance 1420:

$$checkDist = {dist}_{O RU , t} + {vel}_{O RU , t} * {τ}_{s afety} . \qquad ( 27 )$$

The AV distance 1422 represents the predicted distance the AV 1402 will travel along its path by the time of interaction. The classification of the ORU vehicle is determined by comparing the check distance 1424 with the AV distance 1422. If the AV distance 1422 is less than the check distance 1424 (AvDistₜ<checkDistₜ), the ORU vehicle may be classified as a Go After vehicle. In some implementations, the system may use different values for the safety time headway parameter depending on the specific merging scenario. In some implementations, if the ORU vehicle is classified as a Go After vehicle, a virtual stop line 1426 may be enabled. This virtual stop line 1426 may serve as a reference point for the AV 1402 to yield before entering the major road.

FIG. 14C illustrates a scenario 1430 where the AV 1402 has passed the virtual stop line, representing that the AV 1402 is entering the intersection or merging area. At this point, the time headway equation may change from the conservative approach to a more relaxed one, allowing the AV 1402 to merge more easily onto the major road.

The relaxed time headway parameter may be calculated as follows:

$$1 - ( 0.4 / 3 ) * ( {vel}_{A V} - 1 ) , \qquad ( 28 )$$

where t=timeOfInteraction, and

$${checkDist}_{t} = {dist}_{O RU , t} + {vel}_{ORU , t} * {τ}_{safety} . \qquad ( 29 )$$

This relaxed time headway may be used to recalculate the check distance:

$${checkDist}_{t} < {AvDist}_{t} . \qquad ( 30 )$$

FIG. 14D is an example 1450 that shows how the relaxed time headway may affect the classification of ORU vehicles. The check distance 1442 calculated using the relaxed time headway may be shorter than the previous check distance 1424. This may result in more opportunities for the AV 1402 to classify ORU vehicles as Go Before vehicles, facilitating a smoother merge onto the major road.

In some implementations, the AV may also consider additional factors when adjusting the time headway parameter, such as the relative speeds between the AV and ORU vehicles, traffic density on the major road, visibility conditions, and/or road curvature and grade, among other factors. In some implementations, the AV may employ machine learning techniques to optimize the time headway parameters based on historical data and successful merging maneuvers. This approach may allow the AV to adapt its merging behavior to different road types, traffic patterns, and local driving cultures.

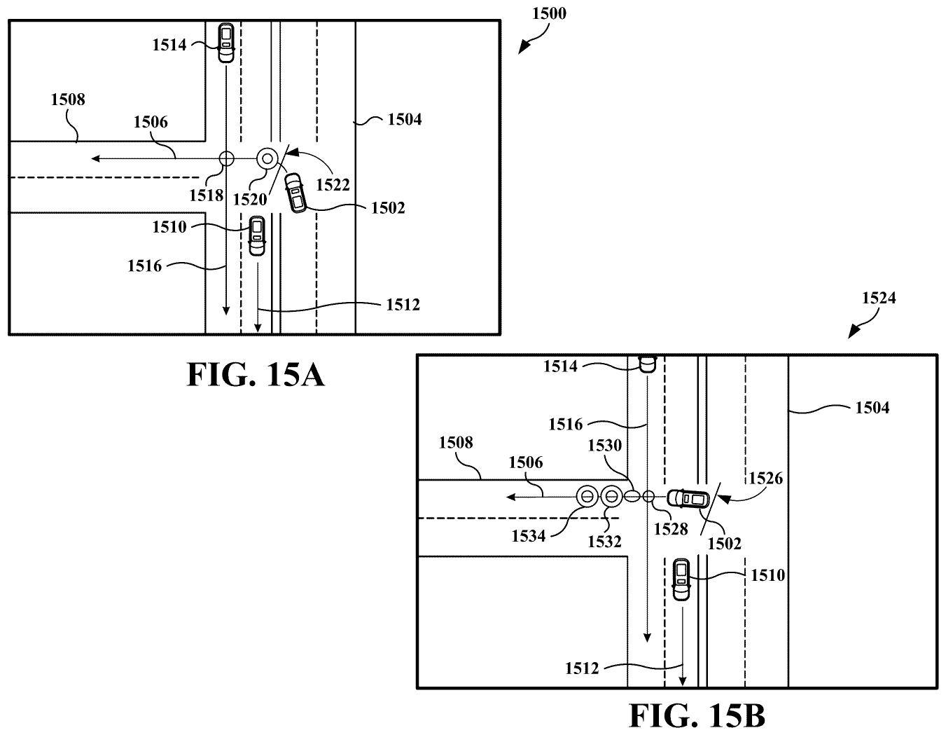

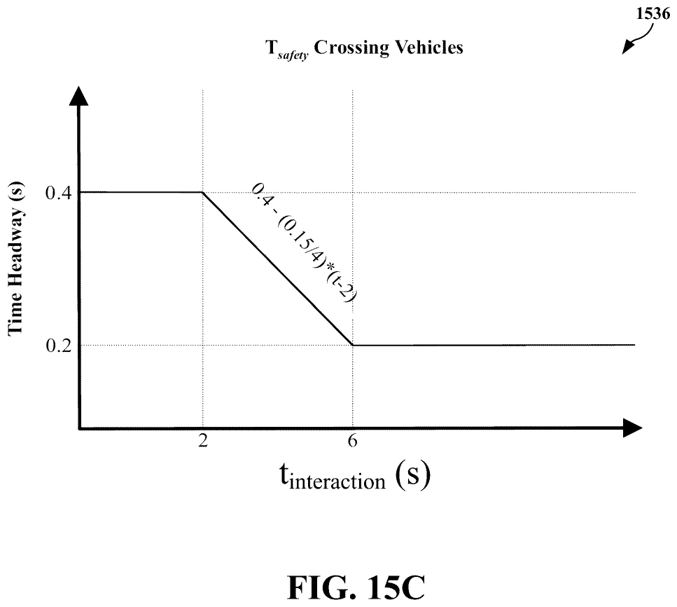

FIGS. 15A-15C illustrate examples associated with merge detection and mitigation in scenarios involving crossing vehicles. These figures depict various scenarios and calculations used in the decision-making process for an AV when making unprotected turns or crossing intersections where crossing vehicles have priority.

FIG. 15A shows an example 1500 of a road scenario where an AV 1502 is traveling on a first road 1504 along an AV path 1506. The AV 1502 is approaching a second road 1508 where the AV 1502 needs to make an unprotected turn. Two crossing ORU vehicles, 1510 and 1514, are shown on the second road 1508, following predicted ORU paths 1512 and 1516, respectively.

In this scenario, the AV 1502 may use a classification algorithm for crossing vehicles that is calculated relative to the time to contact of the ORU with the path of the AV. The classification process may involve a timing parameter equation derived from regulatory rules. The timing parameter is a minimum time-to-collision (TTC) parameter. The TTC parameter is explained in further detail in connection with FIG. 7 above. The minimum TTC, TTCₘᵢₙ, determines the minimum time to contact threshold for the AV to complete its turn. The equation may be expressed as:

$${TTC}_{min} = \frac{{vel}_{ORU}}{2 β} + ρ \qquad ( 31 )$$

where t_{Observed} is the observed velocity of the ORU vehicle,

$$β = 3 \frac{m}{{s}^{2}}$$

(max admissible deceleration) and ρ=2.5 s (conservative reaction time of ORU). The AV 1502 may then calculate the interaction time (t_{interaction}) using the following equation:

$${t}_{interaction} = {t}_{Observed} - TT {C}_{min} \qquad ( 32 )$$

where t_{interaction} is used for object classification and t_{Observed} is a time of interaction based on the observed velocity of the ORU vehicle. As used herein, the interaction time t_{interaction} is a predicted interaction time. The observed velocity vel_{ORU} of the ORU vehicle is used for determining the timing parameter for crossing parameters because, as described above in connection with FIG. 7, the locations of the crossing vehicle (e.g., the ORU vehicle 1514) are not based on a predicted path, over time, of the crossing vehicle but are instead time-based (as opposed to being distance based as for along world objects). As explained in connection with FIG. 7, and as can be observed in the occupancy grid 726, the crossing vehicle 718 of FIG. 7 appears to be stationary over time since the crossing vehicle only briefly crosses the path of the AV.

In some implementations, the t_{interaction} may be used to determine the AV distance along its path relative to the minimal time to contact with the ORU. The AV 1502 may compare its predicted distance (AvDistₜ) at the time of interaction t_{interaction} with an “observed distance” (dist_{ORU}) of the ORU vehicle to classify the ORU vehicle. The observed distance dist_{ORU} is a distance calculated based on the observed velocity of the ORU vehicle vel_{ORU} (as opposed to a predicted velocity vel_{ORU,t} thereof). If the AV 1502 is before a virtual stop line 1522, the AV 1502 may yield to a Go After ORU behind the virtual stop line 1522. This classification may be determined using the following conditions:

$${TTC}_{min} = \frac{{vel}_{ORU}}{2 β} + ρ , and \qquad ( 33 )$$

$${t}_{i n teraction} = {t}_{Observed} - T T {C}_{min} , \qquad ( 34 )$$

where AvDistₜ<dist_{ORU}.

FIG. 15B illustrates an example 1524 where the AV 1502 has passed the virtual stop line 1526. In this scenario, the parameters for minimum time to contact may become less conservative, and a merging algorithm may be applied to classify ORUs. The equations used in this scenario may be:

$${TTC}_{min} = \frac{{vel}_{ORU}}{2 β} + ρ , and \qquad ( 35 )$$

$${t}_{interaction} = {t}_{Observed} - {TTC}_{min} , \qquad ( 36 )$$

where vel_{ORU} is the observed velocity of the ORU vehicle and ρ=1.5 s (AV past virtual stop line, reaction time of ORU). The safety distance may be calculated as:

$$SafetyDist = {vel}_{ORU , t} * {τ}_{safety} \qquad ( 37 )$$

where vel_{ORU,t} is the predicted velocity of the ORU vehicle at the interaction time, t_{interaction} and and τ_{safety} is a predetermined safety time headway parameter. The classification may be determined by comparing the check distance with the AV distance: checkDist<AvDistₜ.

FIG. 15C shows a graph 1536 illustrating the relationship between the time headway range and the ORU interaction distance. The graph 1536 may indicate that a smaller time headway range is used because the ORU interaction distance is fixed. This approach may allow for more precise decision-making in crossing scenarios.

In some implementations, the AV may consider additional factors when classifying crossing vehicles and determining the appropriate action for the AV. These factors may include the speed and acceleration of the crossing ORU vehicles, the geometry of the intersection, the presence of other obstacles or pedestrians, and/or the capabilities of the AV, such as its acceleration and braking performance, among other examples of factors. The AV may also employ machine learning techniques to refine its classification and decision-making processes over time. By analyzing data from successful and unsuccessful crossing maneuvers, the AV may adapt its behavior to different types of intersections, traffic patterns, and local driving cultures. In alternative embodiments, the AV may use a probabilistic approach to classify crossing vehicles. Instead of using fixed thresholds, the system may calculate the probability of a safe crossing based on multiple factors and use this probability to make decisions. This approach may allow for more nuanced decision-making in complex scenarios

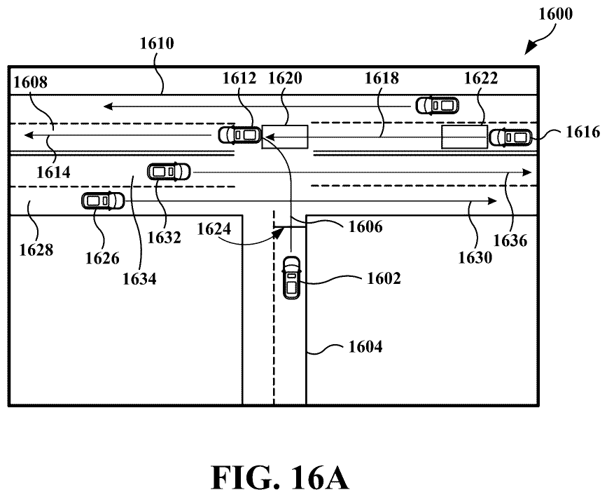

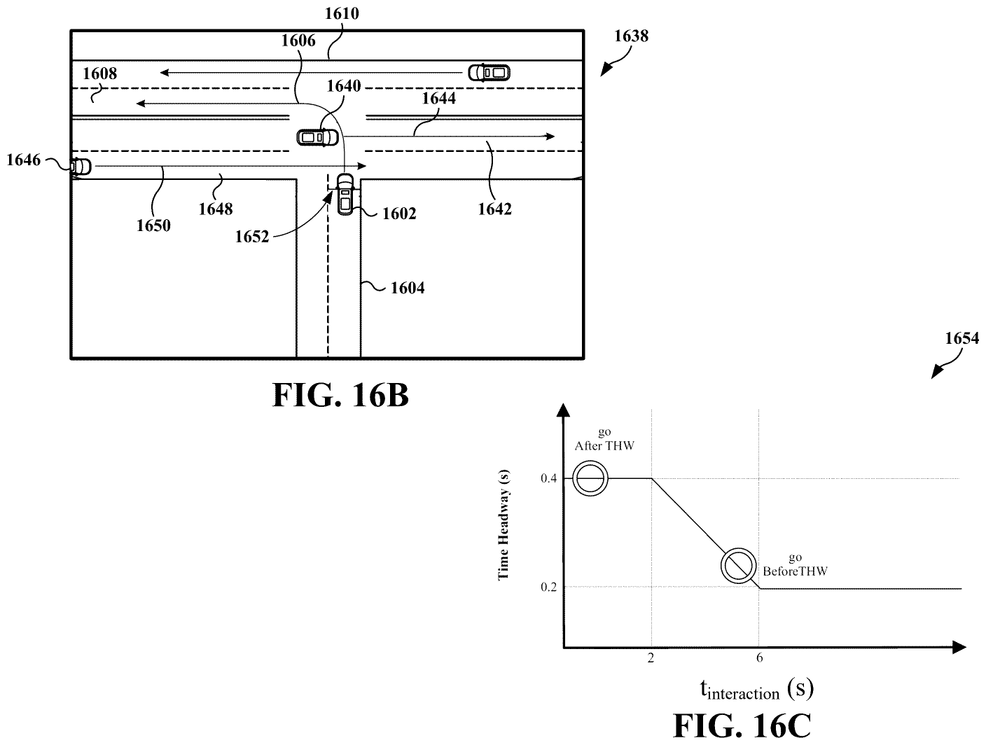

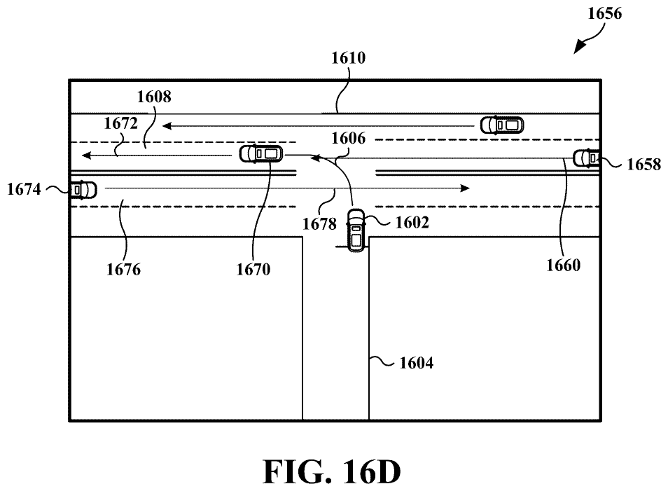

FIGS. 16A-16D illustrate examples associated with merge detection and mitigation in scenarios involving crossing multiple lanes of traffic. These figures depict various scenarios and calculations used in the decision-making process for an AV when navigating complex intersections with multiple lanes and potential interactions with ORUs.

FIG. 16A shows an example 1600 of a road scenario where an AV 1602 is traveling on a first road 1604 along an AV path 1606. The AV 1602 is approaching a multi-lane intersection where the AV 1602 needs to cross and merge into a target lane 1608 on a second road 1610. Multiple ORU vehicles are shown on the second road 1610, including a first ORU vehicle 1612 following a first predicted ORU path 1614 and a second ORU vehicle 1616 following a second predicted ORU path 1618.

In this scenario, the AV 1602 may apply different classification algorithms concurrently for various road structures and ORU interactions. For ORU vehicles interacting with the AV path in a manner similar to highway merging, such as vehicles entering the path of the AV, the AV 1602 may apply merging equations to classify whether vehicles are Go After or Go Before vehicles.

The AV 1602 may calculate a midpoint between Go After and Go Before vehicles using the following equation:

$$midpoint = ( {dist}_{GA , t} + {dist}_{GB , t} ) / 2 \qquad ( 34 )$$

where dist_{GA,t} is the distance of the Go After vehicle at time t, and dist_{GB,t} is the distance of the Go Before vehicle at time t. The AV 1602 may then calculate time headway parameters for Go After and Go Before classifications:

$$goAfterTHW = min ( {τ}_{G A} , max ( 0 \text{.2} , \frac{{dist}_{GA , t} - midpoint + 5}{v e {l}_{A V}} ) ) , and \qquad ( 35 )$$

$$goBeforeTHW = min ( {τ}_{G B} , max ( 0.2 , \frac{midpoint - 5 - {dist}_{GB , t}}{v e {l}_{G B}} ) ) , \qquad ( 36 )$$

where τ_{GA} and τ_{GB} are predefined maximum time headway values for Go After and Go Before vehicles, respectively. The AV 1602 may determine safety distances for Go Before and Go After vehicles:

$${safetyDist}_{GB} = {vel}_{GB , t} * goBeforeTHW , and \qquad ( 37 )$$

$${safetyDist}_{GA} = {vel}_{AV , t} * goAfterTHW . \qquad ( 38 )$$

For crossing vehicles, the AV 1602 may use a classification algorithm similar to that used for oncoming vehicles, but with a more conservative time headway to ensure the AV yields more reliably. The minimum time to contact (TTCₘᵢₙ) may be calculated as:

$$T T {C}_{min} = \frac{{vel}_{O R U}}{2 β} + ρ , \qquad ( 39 )$$

where ρ=2.5 s (conservative reaction time of ORU when the AV is behind the virtual stop line). The interaction time may be determined as:

$${t}_{i n teraction} = {t}_{oberved} - {TTC}_{min} , and \qquad ( 40 )$$

and the AV 1602 may then classify crossing vehicles based on the condition AvDistₜ<dist_{ORU}.

FIG. 16B illustrates an example 1638 where the AV 1602 has crossed a virtual stop line 1652. In this scenario, the AV 1602 may apply a less conservative time headway for crossing vehicles. The equations for TTCₘᵢₙ and t_{interaction} remain the same as equations (39) and (40), but the reaction time ρ is reduced to 1.5 s, reflecting that the AV has passed the virtual stop line. The safety distance for crossing vehicles may be calculated as:

$$SafetyDist = {vel}_{ORU , t} * {τ}_{safety} , \qquad ( 41 )$$

where τ_{safety} is the time headway parameter for crossing vehicles.

FIG. 16C shows a graph 1654 illustrating the relationship between the time headway range and the ORU interaction distance for crossing vehicles. The graph may indicate that a smaller time headway range is used since the ORU interaction distance is fixed, allowing for more precise decision-making in crossing scenarios.

FIG. 16D illustrates an example 1656 where both crossing and merging Go Before vehicles are present. In this scenario, the AV 1602 may apply a window algorithm for both types of Go Before vehicles relative to the Go After vehicle. The Go After vehicle may use the minimum time headway calculated from the two calculations (crossing and merging) to enable the AV to navigate through the unprotected turn. For crossing vehicles, the AV 1602 may calculate:

$$t = {t}_{GB , Xing} , \qquad ( 42 )$$

$${midpoint}_{Xing} = ( {dist}_{GA , t} + {dist}_{GB , Xing , t} ) / 2 ,$$

$${τ}_{GB , Xing} = min ( {τ}_{GB , Xing} , max ( 0.1 , \frac{{midpoint}_{Xing} - 5 - {dist}_{GB , Xing , t}}{{vel}_{GB , xing}} ) ) , and$$

$${τ}_{G A} = min ( {τ}_{G A} , max ( 0.2 , \frac{d i s {t}_{GA , t} - {midpoint}_{Xing} + 5}{{vel}_{A V}} ) ) ,$$

and for merging vehicles, the AV 1602 may calculate:

$$t = {t}_{G B} , \qquad ( 43 )$$

$$midpoint = ( {dist}_{GA , t} + {dist}_{GA , t} ) / 2 ,$$

$${τ}_{G B} = min ( {τ}_{G B} , max ( 0.1 , \frac{midpoint - 5 - d i s {t}_{GB , t}}{{vel}_{G B}} ) ) , and$$

$${τ}_{G A} = min ( {τ}_{G A} , max ( 0.2 , \frac{d i s {t}_{GA , t} - midpoint + 5}{{vel}_{A V}} ) ) .$$

In some implementations, the AV may consider additional factors when classifying vehicles and determining the appropriate action for the AV in multi-lane crossing scenarios. These factors may include, for example, the number of lanes to be crossed, the speed and acceleration of ORU vehicles in each lane, the presence of dedicated turn lanes or protected turn phases, traffic signal timing and phasing, the presence of other obstacles, such as pedestrians or cyclists, or some combination thereof. The AV may also employ machine learning techniques to optimize its decision-making process in complex multi-lane crossing scenarios. By analyzing data from successful and unsuccessful maneuvers, the AV may adapt its behavior to different intersection layouts, traffic patterns, and local driving cultures. In some implementations, the AV may use a probabilistic approach to classify vehicles and determine the optimal path through the intersection. Instead of using fixed thresholds, the AV may calculate the probability of a safe crossing based on multiple factors and use this probability to make decisions. This approach may allow for more nuanced decision-making in complex scenarios with multiple interacting vehicles.

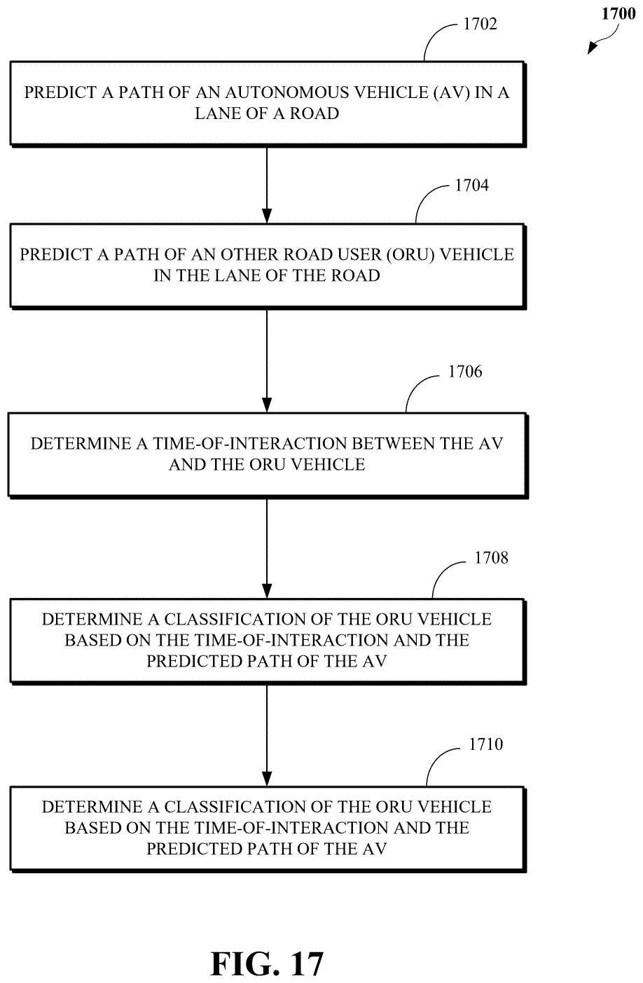

To further describe some implementations in greater detail, reference is next made to examples of techniques which may be performed by or using a system for constraint-based speed profile. FIG. 17 is a flowchart of an example of a technique 1700 for generating a speed profile for an autonomous vehicle. The technique 1700 can be executed using devices, such as the systems, hardware, and software described with respect to FIGS. 1-16D. The technique 1700 can be performed, for example, by executing a machine-readable program or other computer-executable instructions, such as routines, instructions, programs, or other code. The steps, or operations, of the technique 1700, or another technique, method, process, or algorithm described in connection with the implementations disclosed herein can be implemented directly in hardware, firmware, software executed by hardware, circuitry, or a combination thereof.

For simplicity of explanation, the technique 1700 is depicted and described herein as a series of steps or operations. However, the steps or operations of the technique 1700 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1702, the technique 1700 includes predicting a path of an AV in a lane of a road and at 1704, predicting a path of ORU vehicle in the lane of the road.

At 1706, the technique 1700 includes determining an interaction time between the AV and the ORU vehicle.

At 1708, the technique 1700 includes determining a classification of the ORU vehicle based on the interaction time and the predicted path of the AV. In some implementations, determining the classification of the ORU vehicle may include determining an AV distance comprising a predicted distance of the AV at the interaction time, determining an ORU vehicle distance comprising a predicted distance of the ORU vehicle at the interaction time, and determining the classification of the ORU vehicle based on the AV distance and the ORU vehicle distance.

In some implementations, determining the classification of the ORU vehicle may include determining an AV distance comprising a predicted distance of the AV at the interaction time, determining an ORU vehicle distance comprising a predicted distance of the ORU vehicle at the interaction time; determining a check distance based on the ORU vehicle distance, and determining the classification of the ORU vehicle based on a comparison of the AV distance and the check distance. In some implementations, determining the check distance may include determining a safety distance based on a predicted velocity of the ORU vehicle and a time headway parameter, and determining the check distance based on the safety distance and the ORU vehicle distance. In some implementations, the time headway parameter is a function of at least one of the predicted velocity of the ORU vehicle or a relative velocity of the AV and the ORU vehicle.

In some implementations, determining the classification of the ORU vehicle may include classifying the ORU vehicle as a Go After vehicle if the AV distance is less than the check distance, and classifying the ORU vehicle as a Go Before vehicle if the AV distance is greater than the check distance. In some implementations, determining the classification of the ORU vehicle may include determining that the AV distance is less than the check distance, determining that at least one speed condition is satisfied, and classifying the ORU vehicle as a Go Before vehicle based on the determination that the at least one speed condition is satisfied.

At 1710, the technique 1700 includes establishing a speed of the AV based on the classification of the ORU vehicle.

In some implementations, the technique 1700 may further include detecting an additional ORU vehicle in the lane of the road, determining an additional check distance comprising a gap distance between the ORU vehicle and the additional ORU vehicle, determining an additional classification of the additional ORU vehicle based on the interaction time and the additional check distance, and establishing the speed of the AV based on the classification of the ORU vehicle and the additional classification of the additional ORU vehicle. In some implementations, the ORU vehicle may be classified as a Go After vehicle, and determining the additional classification of the additional ORU vehicle may include classifying the additional ORU vehicle as a Go After vehicle based on determining that the additional check distance fails to satisfy a threshold. In some implementations, the ORU vehicle may be classified as a Go Before vehicle, and determining the additional classification of the additional ORU vehicle may include classifying the additional ORU vehicle as a Go Before vehicle based on determining that the additional check distance fails to satisfy a threshold.

In some implementations, the technique 1700 may further include detecting an additional ORU vehicle in the lane of the road, determining an additional predicted distance of the additional ORU vehicle at the interaction time, determining a first time headway parameter for the ORU vehicle and a second time headway parameter for the additional ORU vehicle, determining an upper bound constraint for the AV based on the first time headway parameter and the second time headway parameter, determining a lower bound constraint for the AV based on the first time headway parameter, and establishing the speed of the AV based on the upper bound constraint and the lower bound constraint.

In some implementations, the technique 1700 may further include determining that the AV is merging onto a major road from a minor road, determining a time headway parameter based on determining that the AV is merging onto the major road from the minor road, and establishing the speed of the AV based on the time headway parameter. In some implementations, the technique 1700 may further include enabling a virtual stop line based on classifying the ORU vehicle as a Go After vehicle. In some implementations, the technique 1700 may further include determining that the AV is passing the virtual stop line, adjusting the time headway parameter based on determining that the AV is passing the virtual stop line, and establishing the speed of the AV based on the adjusted time headway parameter.

In some implementations, the technique 1700 may further include classifying the ORU vehicle as a crossing vehicle based on a comparison between a time to contact with a predicted path of the AV and a minimum time to contact threshold, and establishing the speed of the AV based on the classification of the ORU vehicle. In some implementations, the technique 1700 may further include determining that the AV is before a virtual stop line, and yielding to the ORU vehicle based on classifying the ORU vehicle as a Go After vehicle, wherein the ORU vehicle is behind the virtual stop line.

While not specifically shown in FIG. 17, the technique 1700 can be continuously performed (such as at every time step) while the AV is being autonomously controlled.

A world object of the world objects may be identified as an along path world object. In such a case, the respective buffer distances corresponding to the world object can be based on a time headway to the world object. A world object may be identified as a crossing world object. In such a case, the respective buffer distances corresponding to the world object can be based on a time to collision between the AV and the world object. As described above, in response to determining that a crossing lane is obstructed to sensors of the AV, the technique 1700 may place a virtual along path vehicle in the occupancy grid.

For simplicity of explanation, each technique herein is depicted and described as a series of operations. However, the operations in accordance with this disclosure can occur in various orders and/or concurrently. Additionally, other steps or operations not presented and described herein may be used. Furthermore, not all illustrated operations may be required to implement a technique in accordance with the disclosed subject matter.

As used herein, the terminology “driver” or “operator” may be used interchangeably. As used herein, the terminology “brake” or “decelerate” may be used interchangeably. As used herein, the terminology “computer” or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
predicting a path of an autonomous vehicle (AV) in a lane of a road;
predicting a path of an other road user (ORU) vehicle in the lane of the road;
determining an interaction time between the AV and the ORU vehicle;
determining a classification of the ORU vehicle based on the interaction time and the predicted path of the AV; and
establishing a speed of the AV based on the classification of the ORU vehicle.

2. The method of claim 1, wherein determining the classification of the ORU vehicle comprises:
determining an AV distance comprising a predicted distance of the AV at the interaction time;
determining an ORU vehicle distance comprising a predicted distance of the ORU vehicle at the interaction time; and
determining the classification of the ORU vehicle based on the AV distance and the ORU vehicle distance.

3. The method of claim 1, wherein determining the classification of the ORU vehicle comprises:
determining an AV distance comprising a predicted distance of the AV at the interaction time;
determining an ORU vehicle distance comprising a predicted distance of the ORU vehicle at the interaction time;
determining a check distance based on the ORU vehicle distance; and
determining the classification of the ORU vehicle based on a comparison of the AV distance and the check distance.

4. The method of claim 3, wherein determining the check distance comprises:
determining a safety distance based on a predicted velocity of the ORU vehicle and a time headway parameter; and
determining the check distance based on the safety distance and the ORU vehicle distance.

5. The method of claim 4, wherein the time headway parameter is a function of at least one of the predicted velocity of the ORU vehicle or a relative velocity of the AV and the ORU vehicle.

6. The method of claim 3, wherein determining the classification of the ORU vehicle comprises:
classifying the ORU vehicle as a Go After vehicle if the AV distance is less than the check distance; and
classifying the ORU vehicle as a Go Before vehicle if the AV distance is greater than the check distance.

7. The method of claim 3, wherein determining the classification of the ORU vehicle comprises:
determining that the AV distance is less than the check distance;
determining that at least one speed condition is satisfied; and
classifying the ORU vehicle as a Go Before vehicle based on the determination that the at least one speed condition is satisfied.

8. The method of claim 1, further comprising:
detecting an additional ORU vehicle in the lane of the road;
determining an additional check distance comprising a gap distance between the ORU vehicle and the additional ORU vehicle;
determining an additional classification of the additional ORU vehicle based on the interaction time and the additional check distance; and
establishing the speed of the AV based on the classification of the ORU vehicle and the additional classification of the additional ORU vehicle.

9. The method of claim 8, wherein the ORU vehicle is classified as a Go After vehicle, and wherein determining the additional classification of the additional ORU vehicle comprises classifying the additional ORU vehicle as a Go After vehicle based on determining that the additional check distance fails to satisfy a threshold.

10. The method of claim 8, wherein the ORU vehicle is classified as a Go Before vehicle, and wherein determining the additional classification of the additional ORU vehicle comprises classifying the additional ORU vehicle as a Go Before vehicle based on determining that the additional check distance fails to satisfy a threshold.

11. The method of claim 1, further comprising:
detecting an additional ORU vehicle in the lane of the road;
determining an additional predicted distance of the additional ORU vehicle at the interaction time;
determining a first time headway parameter for the ORU vehicle and a second time headway parameter for the additional ORU vehicle;
determining an upper bound constraint for the AV based on the first time headway parameter and the second time headway parameter;
determining a lower bound constraint for the AV based on the first time headway parameter; and
establishing the speed of the AV based on the upper bound constraint and the lower bound constraint.

12. The method of claim 1, further comprising:
determining that the AV is merging onto a major road from a minor road;
determining a time headway parameter based on determining that the AV is merging onto the major road from the minor road; and
establishing the speed of the AV based on the time headway parameter.

13. The method of claim 12, further comprising:
enabling a virtual stop line based on classifying the ORU vehicle as a Go After vehicle.

14. The method of claim 13, further comprising:
determining that the AV is passing the virtual stop line;
adjusting the time headway parameter based on determining that the AV is passing the virtual stop line; and
establishing the speed of the AV based on the adjusted time headway parameter.

15. The method of claim 1, further comprising:
classifying the ORU vehicle as a crossing vehicle based on a comparison between a time to contact with a predicted path of the AV and a minimum time to contact threshold; and
establishing the speed of the AV based on the classification of the ORU vehicle.

16. The method of claim 15, further comprising:
determining that the AV is before a virtual stop line; and
yielding to the ORU vehicle based on classifying the ORU vehicle as a Go After vehicle, wherein the ORU vehicle is behind the virtual stop line.

17. A vehicle, comprising:
one or more sensors;
a memory; and
a processor configured to execute instructions stored in the memory to:
predict a path of an autonomous vehicle (AV) in a lane of a road;
predict a path of an other road user (ORU) vehicle in the lane of the road;
determine an interaction time between the AV and the ORU vehicle;
determine a classification of the ORU vehicle based on the interaction time and the predicted path of the AV; and
establish a speed of the AV based on the classification of the ORU vehicle.

18. The vehicle of claim 17, wherein determining the classification of the ORU vehicle comprises:
determining an AV distance comprising a predicted distance of the AV at the interaction time;
determining an ORU vehicle distance comprising a predicted distance of the ORU vehicle at the interaction time; and
determining the classification of the ORU vehicle based on the AV distance and the ORU vehicle distance.

19. The vehicle of claim 17, wherein determining the classification of the ORU vehicle comprises:
determining an AV distance comprising a predicted distance of the AV at the interaction time;
determining an ORU vehicle distance comprising a predicted distance of the ORU vehicle at the interaction time;
determining a check distance based on the ORU vehicle distance; and
determining the classification of the ORU vehicle based on a comparison of the AV distance and the check distance.

20. A non-transitory computer-readable medium storing instructions operable to cause one or more processors to perform operations comprising:
predicting a path of an autonomous vehicle (AV) in a lane of a road;
predicting a path of an other road user (ORU) vehicle in the lane of the road;
determining an interaction time between the AV and the ORU vehicle;
determining a classification of the ORU vehicle based on the interaction time and the predicted path of the AV; and
establishing a speed of the AV based on the classification of the ORU vehicle.
